(19) United States
(12) Patent Application Publication
(10) Pub. No.: US 2026/0059563 A1
(43) Pub. Date: Feb. 26, 2026

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Zhenshan ZHAO, Dongguan (CN); Yi DING, Dongguan (CN)

(21) Appl. No.: 19/379,511

(22) Filed: Nov. 4, 2025

Related U.S. Application Data
(63) Continuation of application No. PCT/CN2023/093175, filed on May 10, 2023.

(51) Int. Cl. H04W 72/40; H04W 76/28; H04W 92/18

(52) U.S. Cl. CPC H04W 72/40; H04W 76/28; H04W 92/18

(57) ABSTRACT

A wireless communication method a includes: detecting, by a first terminal, first indication information transmitted by a second terminal, the first indication information being used to indicate that the first terminal is to enter a target state; the target state being used to indicate whether the first terminal starts a first timer, or the target state being used to indicate whether the first terminal receives sidelink data within a first time range; where the first timer is related to a sidelink discontinuous reception duration timer, and the first time range is determined based on the first timer; and transmitting, by the first terminal, sidelink feedback information of the first indication information to the second terminal.

### CROSS-REFERENCE TO RELATED APPLICATION

This application is a Continuation Application of International Application No. PCT/CN2023/093175 filed on May 10, 2023, which is incorporated herein by reference in its entirety.

### TECHNICAL FIELD

Embodiments of the present disclosure relate to the field of communication, and specifically, to wireless communication methods and terminal devices.

### BACKGROUND

In order to reduce the energy consumption of terminals, it is considered to introduce a wake-up signal (WUS) in a sidelink (SL) system to indicate that a receiving end terminal is to enter a wake-up or sleep state. However, the network environment is complex and ever-changing. How to ensure that a transmitting end terminal and the receiving end terminal have a consistent understanding of the state of the receiving end terminal, thereby ensuring the reliability of sidelink transmission, is an urgent problem that needs to be addressed.

### SUMMARY

The present disclosure provides wireless communication methods and terminal devices, which are conducive to ensuring that a transmitting end terminal and a receiving end terminal have a consistent understanding of a state of the receiving end terminal, thereby ensuring the reliability of sidelink transmission.

In a first aspect, a wireless communication method is provided, including: detecting, by a first terminal, first indication information transmitted by a second terminal, the first indication information being used to indicate that the first terminal is to enter a target state; the target state being used to indicate whether the first terminal starts a first timer, or the target state being used to indicate whether the first terminal receives sidelink data within a first time range; where the first timer is related to a sidelink discontinuous reception duration timer, and the first time range is determined based on the first timer; and transmitting, by the first terminal, sidelink feedback information of the first indication information to the second terminal.

In a second aspect, a wireless communication method is provided, including: transmitting, by a second terminal, first indication information to a first terminal, the first indication information being used to indicate that the first terminal is to enter a target state; the target state being used to indicate whether the first terminal starts a first timer, or the target state being used to indicate whether the first terminal receives sidelink data within a first time range; where the first timer is related to a sidelink discontinuous reception duration timer, and the first time range is determined based on the first timer; and receiving, by the second terminal, sidelink feedback information of the first indication information transmitted by the first terminal.

In a third aspect, a terminal device is provided, for performing the method in the above-mentioned first aspect or various implementations thereof.

In some embodiments, the terminal device includes a functional module for performing the method in the above-mentioned first aspect or the various implementations thereof.

In a fourth aspect, a terminal device is provided, for performing the method in the above-mentioned second aspect or various implementations thereof.

In some embodiments, the terminal device includes a functional module for performing the method in the above-mentioned second aspect or the various implementations.

In a fifth aspect, a terminal device is provided, including a processor and a memory. The memory is configured to store a computer program, and the processor is configured to call the computer program stored in the memory and run the computer program to perform the method in the above-mentioned first aspect or the various implementations thereof.

In a sixth aspect, a terminal device is provided, including a processor and a memory. The memory is configured to store a computer program, and the processor is configured to call the computer program stored in the memory and run the computer program to perform the method in the above-mentioned second aspect or the various implementations thereof.

In a seventh aspect, a chip is provided for implementing the method in any one of the above-mentioned first to second aspects or each of the implementations thereof. In some embodiments, the chip includes: a processor, which is configured to call a computer program from a memory and run the computer program, to enable a device equipped with the chip to perform the method in any one of the above-mentioned first to second aspects or each of the implementations thereof.

In an eighth aspect, a non-transitory computer-readable storage medium is provided, for storing a computer program, where the computer program enables a computer to perform the method in any one of the above-mentioned first to second aspects or each of the implementations thereof.

In a ninth aspect, a computer program product is provided, including computer program instructions, where the computer program instructions enable a computer to perform the method in any one of the above-mentioned first to second aspects or each of their implementations.

In a tenth aspect, a computer program is provided, which, when executed on a computer, enables the computer to execute the method in any one of the above-mentioned first to second aspects or each of the implementations thereof.

### BRIEF DESCRIPTION OF THE DRAWINGS

FIG. 1 is a schematic diagram of a communication system architecture provided in the present disclosure.

FIG. 2 is a schematic diagram of another communication system architecture provided in the present disclosure.

FIG. 3 is a schematic diagram of sidelink communication within a network coverage area provided in the present disclosure.

FIG. 4 is a schematic diagram of sidelink communication of partial network coverage provided in the present disclosure.

FIG. 5 is a schematic diagram of sidelink communication outside network coverage provided in the present disclosure.

FIG. 6 is a schematic diagram of unicast sidelink communication provided in the present disclosure.

FIG. 7 is a schematic diagram of multicast sidelink communication provided in the present disclosure.

FIG. 8 is a schematic diagram of broadcast sidelink communication provided in the present disclosure.

FIGS. 9 and 10 are schematic diagrams of a slot structure in an NR SL system.

FIG. 11 is a schematic diagram of a terminal energy-saving mechanism based on an energy-saving signal.

FIG. 12 is a schematic interaction diagram of a wireless communication method provided in embodiments of the present disclosure.

FIG. 13 is a schematic diagram of a time domain position of a second time domain resource in accordance with embodiments of the present disclosure.

FIG. 14 is a schematic diagram of a time domain position of another second time domain resource in accordance with embodiments of the present disclosure.

FIG. 15 is a schematic diagram of a time domain resource of a first indication information provided in embodiments of the present disclosure.

FIG. 16 is a schematic diagram of a time domain resource of another first indication information provided in embodiments of the present disclosure.

FIG. 17 is a schematic diagram of a time domain resource of yet another first indication information provided in embodiments of the present disclosure.

FIG. 18 is a schematic diagram of a time domain resource of a first sidelink channel provided in embodiments of the present disclosure.

FIG. 19 is a schematic block diagram of a terminal device provided in accordance with embodiments of the present disclosure.

FIG. 20 is a schematic block diagram of another terminal device provided in accordance with embodiments of the present disclosure.

FIG. 21 is a schematic block diagram of a communication device provided in accordance with embodiments of the present disclosure.

FIG. 22 is a schematic block diagram of a chip provided in accordance with embodiments of the present disclosure.

FIG. 23 is a schematic block diagram of a communication system provided in accordance with embodiments of the present disclosure.

### DETAILED DESCRIPTION

The technical solutions in the embodiments of the present disclosure will be described below in conjunction with the drawings in the embodiments of the present disclosure. Obviously, the described embodiments are only part of the embodiments of the present disclosure, rather than all of the embodiments. With respect to the embodiments in the present disclosure, all other embodiments obtained by ordinary technicians in this field shall fall within the scope of protection of the present disclosure.

The technical solutions of the embodiments of the present disclosure may be applied to various communication systems, such as: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area networks (WLAN), a wireless fidelity (WiFi), a fifth-generation communication (5th-Generation, 5G) system, or other communication systems.

Generally speaking, traditional communication systems support a limited number of connections, which are easy to be implemented. However, with the development of communication technology, mobile communication systems will not only support traditional communication, but will also support, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

Optionally, a communication system in the embodiments of the present disclosure may be applied to a carrier aggregation (CA) scenario, may also be applied to a dual connectivity (DC) scenario, and may also be applied to a standalone (SA) networking scenario.

Optionally, the communication system in the embodiments of the present disclosure may be applied to an unlicensed spectrum, where the unlicensed spectrum may also be considered as a shared spectrum; or the communication system in the embodiments of the present disclosure may also be applied to an authorized spectrum, where the authorized spectrum may also be considered as an unshared spectrum.

The embodiments of the present disclosure describe various embodiments in conjunction with network devices and terminal devices, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or user device, or the like.

The terminal device may be a station (STATION, ST) in a WLAN, which may be a cellular phone, a cordless phone, a session initiation protocol (SIP) phone, a wireless local loop (WLL) station, a personal digital assistant (PDA) device, a handheld device with wireless communication function, a computing device or any of other processing devices connected to a wireless modem, a vehicle-mounted device, a wearable device, a terminal device in a next-generation communication system (such as an NR network), or a terminal device in a future evolved public land mobile network (PLMN) network.

In the embodiments of the present disclosure, the terminal device may be deployed on land, including indoors or outdoors, handheld, wearable or vehicle-mounted; it may also be deployed on the water surface (such as ships); and it may also be deployed in the air (such as on airplanes, balloons, and satellites).

In the embodiments of the present disclosure, the terminal device may be a mobile phone, a tablet computer (Pad), a computer with wireless transceiver function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home.

As an example but not a limitation, in the embodiments of the present disclosure, the terminal device may also be a wearable device. The wearable device may also be referred to as a wearable smart device, which is a generic term for wearable devices, into which the daily wear is intelligently designed and developed by applying wearable technologies, such as glasses, gloves, watches, clothing, and shoes. The wearable device is a portable device that can be worn directly on the body, or integrated into the user's clothing or accessories. The wearable device is not just a hardware device, but also accomplishes powerful functions through software supporting, data interaction, and cloud interaction. Generalized wearable smart devices include those are fully functional, large in size, and can accomplish all or part of functions without relying on a smartphone, such as smart watches or smart glasses, as well as those that, only focus on a certain type of application function and need to be used in conjunction with other devices (such as a smartphone), such as various types of smart bracelets or smart jewelry for monitoring physical sign.

In the embodiments of the present disclosure, the network device may be a device for communicating with a mobile device. The network device may be an access point (AP) in WLAN, a base station (Base Transceiver Station, BTS) in GSM or CDMA, a base station (NodeB, NB) in WCDMA, an evolved base station (eNB or eNodeB) in LTE, a relay station or access point, a vehicle-mounted device, a wearable device, a network device or base station (gNB) in an NR network, a network device in a future evolved PLMN network, or a network device in an NTN network.

As an example but not limitation, in the embodiments of the present disclosure, the network device may have a mobile feature, for example, the network device may be a movable device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station arranged on land, water, or the like.

In the embodiments of the present disclosure, the network device may provide services for a cell, and the terminal device may communicate with the network device through transmission resources (such as frequency domain resources or spectrum resources) used by the cell. The cell may be a cell corresponding to a network device (e.g., a base station). The cell may belong to a macro base station or a base station corresponding to a small cell. The small cells here may include: a metro cell, a micro cell, a pico cell, a femto cell, etc. These small cells have the characteristics of small coverage and low transmission power, and are suitable for providing high-speed data transmission services.

It should be understood that the terms “system” and “network” are often used interchangeably herein. The term “and/or” herein is merely a description of the association relationship of associated objects, indicating that three relationships may exist. For example, A and/or B may mean: A exists alone, A and B exist simultaneously, and B exists alone. In addition, the character “/” herein generally indicates that the associated objects before and after this character are in an “or” relationship.

The terms used in the implementation section of the present disclosure are only used to explain the exemplary embodiments of the present disclosure and are not intended to limit the present disclosure. The terms “first,” “second,” “third,” “fourth,” and the like in the specification, claims and drawings of the present disclosure are used to distinguish different objects rather than to describe a specific order. In addition, the terms “includes,” “comprises,” “has,” and any variations thereof, are intended to cover a non-exclusive inclusion.

It should be understood that the “indicate” mentioned in the embodiments of the present disclosure may mean a direct indication or an indirect indication, or may represent that there is an association relationship. By way of example, A indicates B, which may mean that A directly indicates B, for example, B may be obtained by A; A indicates B, which may also mean that A indirectly indicates B, for example, A indicates C, and B may be obtained by C; and A indicates B, which may also mean that there is an association relationship between A and B.

In the description of the embodiments of the present disclosure, the term “correspond” may mean that there is a direct correspondence or an indirect correspondence between the two, or may mean that there is an association relationship between the two, or may mean a relationship of indicating and being indicated or a relationship of configuring and being configured.

In the embodiments of the present disclosure, “pre-defined” or “pre-configured” may be implemented by pre-storing corresponding codes, tables, or other methods available for indicating related information in devices (e.g., including a terminal device and a network device), and its specific implementation is not limited in the present disclosure. For example, the “pre-defined” may refer to what is defined in the protocol.

In the embodiments of the present application, the term “protocol” may refer to standard protocols in the field of communication, which may include, for example, an LTE protocol, an NR protocol, and a related protocol used in future communication systems, which is not limited in the present disclosure.

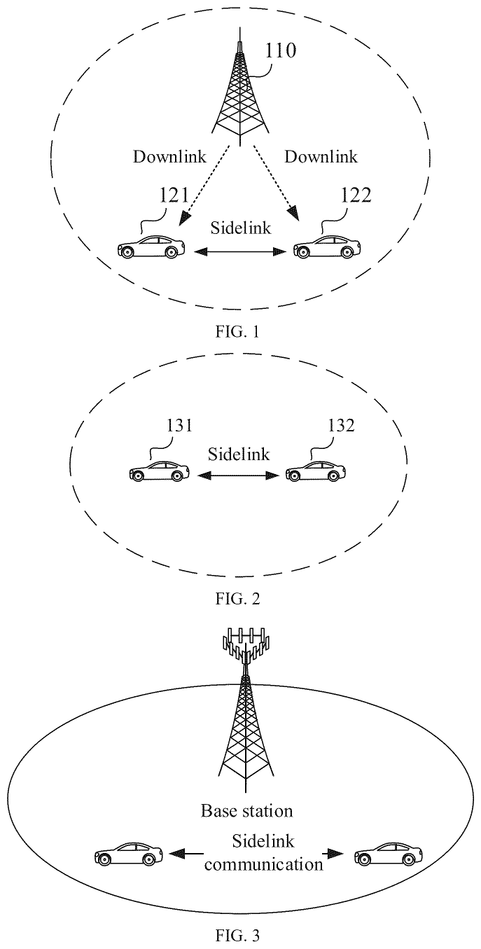

FIG. 1 is a schematic diagram of a communication system to which the embodiments of the present disclosure are applicable. Transmission resources of vehicle-mounted terminals (a vehicle-mounted terminal 121 and a vehicle-mounted terminal 122) are allocated by a base station 110, and the vehicle-mounted terminals transmit data on a sidelink according to the resources allocated by the base station 110. In some embodiments, the base station 110 may allocate resources for single transmission to the terminals, or may allocate resources for semi-static transmission to the terminals.

FIG. 2 is a schematic diagram of another communication system to which the embodiments of the present disclosure are applicable. Vehicle-mounted terminals (a vehicle-mounted terminal 131 and a vehicle-mounted terminal 132) autonomously select transmission resources on resources of a sidelink for data transmission. Optionally, the vehicle-mounted terminal may select a transmission resource randomly, or select a transmission resource by listening.

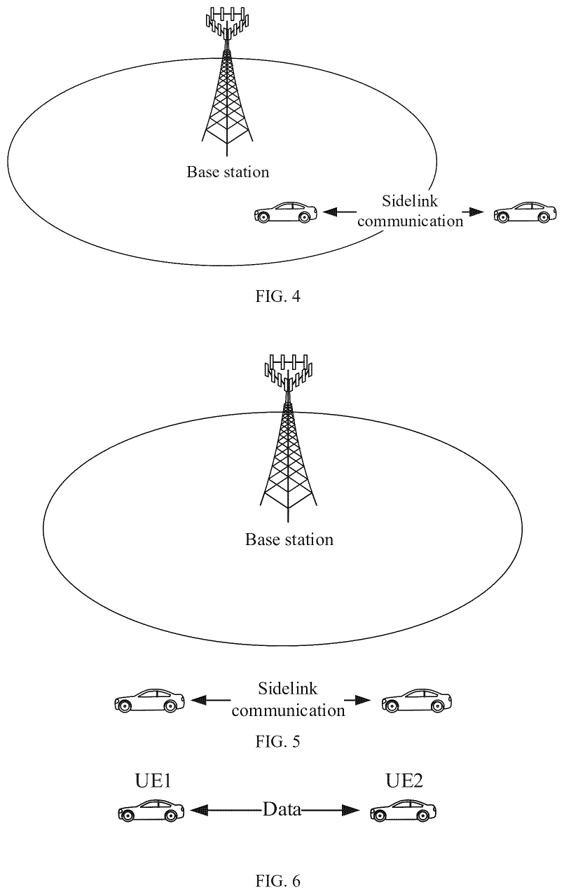

It will be noted that depending on the network coverage of a terminal performing communication, sidelink communication may be classified into: sidelink communication within network coverage, as shown in FIG. 3, sidelink communication of partial network coverage, as shown in FIG. 4, and sidelink communication outside network coverage, as shown in FIG. 5.

FIG. 3: in the sidelink communication within the network coverage, all terminals performing the sidelink communication are within the coverage of the base station. Thus, the above terminals may perform the sidelink communication based on a same sidelink configuration, by receiving configuration signaling of the base station.

FIG. 4: in a case of the sidelink communication of partial network coverage, some terminals performing the sidelink communication are located within the coverage of the base station. These terminals are able to receive configuration signaling of the base station and perform the sidelink communication according to the configuration of the base station. Whereas, terminals outside the network coverage cannot receive the configuration signaling of the base station. In this case, the terminals outside the network coverage will determine the sidelink configuration based on pre-configuration information and information carried in a physical sidelink broadcast channel (PSBCH) transmitted by the terminals within the network coverage, and perform the sidelink communication.

FIG. 5: for the sidelink communication outside the network coverage, all terminals performing the sidelink communication are located outside the network coverage, and all terminals determine a sidelink configuration based on pre-configuration information to perform the sidelink communication.

It will be noted that device-to-device communication is a sidelink (SL) transmission technology based on terminal-to-terminal (Device to Device, D2D). Different from the way communication data is received or transmitted by a base station in traditional cellular systems, an Internet of Vehicles system adopts terminal-to-terminal direct communication, so it has higher spectrum efficiency and lower transmission delay. There are two transmission modes defined in 3GPP, which are respectively referred to as a first mode and a second mode.

The first mode: transmission resources of the terminal are allocated by the base station, and the terminal transmits data on the sidelink according to the resources allocated by the base station; the base station may allocate resources for a single transmission to the terminal, and may also allocate resources for semi-static transmission to the terminal. As shown in FIG. 3, the terminal is located within the coverage of a network, and the network allocates transmission resources used for sidelink transmission to the terminal.

The second mode: The terminal selects one resource in a resource pool to transmit data. As shown in FIG. 5, the terminal is located outside the coverage of a network, and the terminal autonomously selects a transmission resource from a pre-configured resource pool to perform sidelink transmission; or as shown in FIG. 3, the terminal autonomously selects a transmission resource from a resource pool configured by the network to perform sidelink transmission.

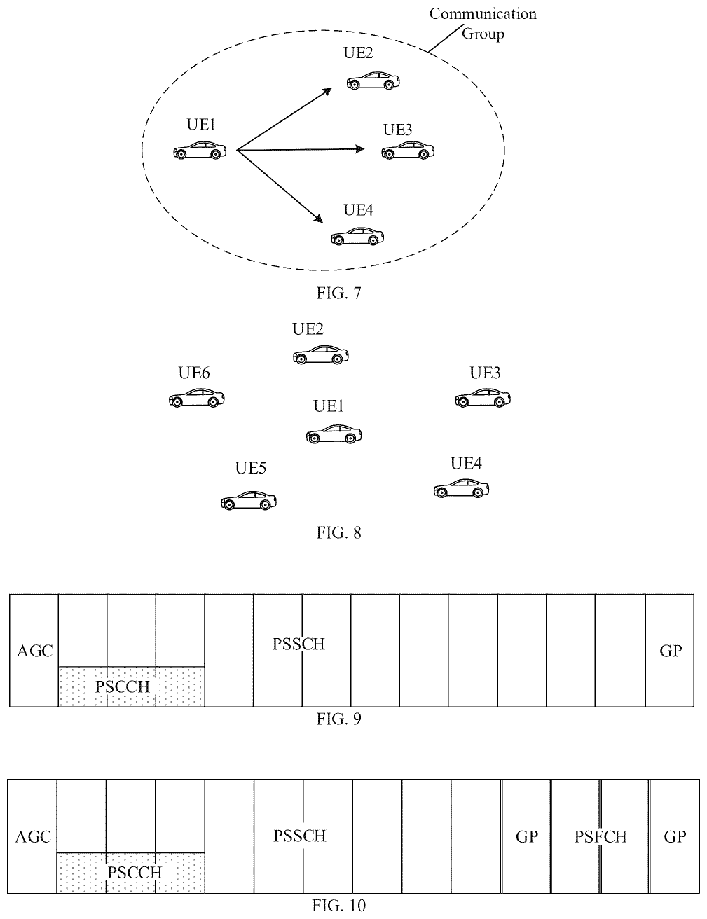

An NR SL system supports unicast, multicast and broadcast transmission methods. For unicast transmission, there is only one terminal at its receiving end terminal, and as shown in FIG. 6, UE1 and UE2 perform unicast transmission between each other. For multicast transmission, its receiving end terminals are all terminals in a communication group, or all terminals within a certain transmission distance and as shown in FIG. 7, UE1, UE2, UE3 and UE4 constitute a communication group, where UE1 transmits data, and other terminal devices in the group are all receiving end terminals. For broadcast transmission, its receiving end terminal is any one terminal around a transmitting end terminal, and as shown in FIG. 8, UE1 is the transmitting end terminal, and other terminals around it, UE2 to UE6, are all receiving end terminals.

To facilitate a better understanding of the embodiments of the present disclosure, a slot structure in the NR SL system is described in combination with FIGS. 9 and 10.

FIG. 9 illustrates a slot structure in which a physical sidelink feedback channel (PSFCH) is not included in the slot; and FIG. 10 illustrates a slot structure in which a PSFCH channel is included.

A physical sidelink control channel (PSCCH) in the NR SL system starts from the second sidelink symbol of the slot in the time domain, occupies 2 or 3 OFDM symbols, and may occupy {10, 12, 15, 20, 25} physical resource blocks (PRBs) in the frequency domain. In order to reduce the complexity of blind detection of PSCCH by UE, only one number of PSCCH symbols and one number of PRBs are allowed to be configured in one resource pool. In addition, because a subchannel is the minimum granularity of physical sidelink shared channel (PSSCH) resource allocation in NR SL, the number of PRBs occupied by PSCCH must be less than or equal to the number of PRBs contained in one subchannel in the resource pool to avoid additional restrictions on PSSCH resource selection or allocation. The PSSCH also starts from the second sidelink symbol of the slot in the time domain, where the last time domain symbol in the slot is a guard period (GP) symbol, and the remaining symbols are mapped to the PSSCH. The first sidelink symbol in the slot is a repetition of the second sidelink symbol. Usually, the receiving end terminal uses the first sidelink symbol as an automatic gain control (AGC) symbol, and data on that symbol is usually not used for data demodulation. The receiving end uses the time of that symbol to perform AGC training or adjustment, so that symbol may also be called an AGC symbol. The PSSCH occupies P subchannels in the frequency domain, with each subchannel including Q consecutive PRBs, where P and Q are positive integers, as shown in FIG. 9.

In a case where the slot contains PSFCH, the second-to-last and third-to-last symbols in the slot are used for PSFCH channel transmission, where data on the third-to-last symbol is a repetition of data on the second-to-last symbol, and that symbol may also be called an AGC symbol. One time domain symbol before the PSFCH channel is used as a GP symbol, as shown in FIG. 10.

To facilitate understanding of the embodiments of the present disclosure, the terminal energy-saving mechanism in the NR system is described.

Since the energy consumption of a terminal in a connected state accounts for the vast majority of the terminal's energy consumption, a wake-up signal is introduced to save energy for a terminal in a radio resource control (RRC) connected state.

The traditional terminal energy-saving mechanism is mainly a discontinuous reception (DRX) mechanism. In a case where DRX is configured, the terminal monitors the physical downlink control channel (PDCCH) within a DRX active time. If receiving data scheduling, the terminal continues to monitor the PDCCH based on the control of a DRX timer until the data transmission is completed; otherwise, if the terminal does not receive the data scheduling within the DRX active time, the terminal enters an inactive period to implement energy-saving. It may be seen that DRX is an energy-saving control mechanism with a DRX cycle as the time granularity, and therefore cannot accomplish optimal power consumption control. For example, even if the terminal has no data scheduling, the terminal still needs to periodically start the DRX ON Duration timer and monitor the PDCCH during the running period of the timer, so there is still a power waste.

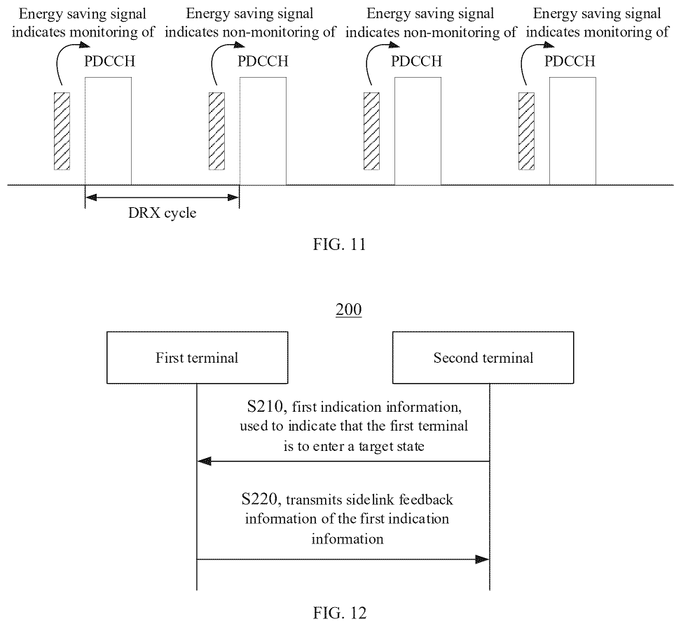

In order to accomplish further energy-saving of the terminal, NR energy-saving enhancement introduces an energy-saving signal (also known as a wake-up signal or an energy-saving wake-up signal). The energy-saving signal is used in conjunction with the DRX mechanism. The technical principle is that the terminal receives an indication of the energy-saving signal before a DRX ON duration. As shown in FIG. 11, in a case where the terminal has data transmission in a DRX cycle, the energy-saving signal “wakes up” the terminal to monitor the PDCCH during the DRX ON duration; otherwise, in a case where the terminal has no data transmission in a DRX cycle, the energy-saving signal does not “wake up” the terminal, so the terminal does not need to monitor the PDCCH during the DRX ON duration. Compared with the DRX mechanism, in a case where the terminal has no data transmission, the terminal may omit monitoring the PDCCH during the DRX ON duration, thereby accomplishing energy-saving of the terminal.

During the sidelink communication process, due to the power-saving requirements of the terminal, appropriate power-saving technology should be introduced to reduce the energy consumption of the UE. If a receiving UE is always in an active state during the sidelink communication process, that continuous reception behavior will cause some unnecessary energy consumption. Therefore, it is considered to introduce a sidelink discontinuous reception (SL-DRX) mechanism to meet the power-saving requirements in sidelink communication, by controlling the “activation” and “inactivation” of the UE's receiving behavior on the sidelink. If the UE is configured/pre-configured with SL-DRX, the UE is allowed not to receive PSCCH/PSSCH during the SL-DRX inactive time to save terminal power consumption.

For the receiving UE using SL-DRX, its active time includes the running time of the SL-DRX duration timer (sl-drx-onDurationTimer), the running time of the SL-DRX inactivity timer (sl-drx-InactivityTimer), the running time of the SL-DRX retransmission timer (sl-drx-RetransmissionTimer), and a period of time after transmitting a CSI report request. During the active time of the UE, the UE performs detection of sidelink control information (SCI) (including the first-stage SCI on the PSCCH and the second-order SCI on the PSSCH) for the purpose of data reception. The UE may skip detecting SCI for the purpose of data reception during the SL-DRX inactive time.

In the sidelink communication, some timers may be defined to control the SL-DRX behavior:
SL-DRX duration timer (sl-drx-onDurationTimer): a periodic DRX activity timer, with the length of time that the UE waits to receive the PSCCH/PSSCH after being activated. If the UE successfully decodes the PSCCH/PSSCH, the UE starts an inactivity timer and remains in the active state;
SL-DRX inactivity timer (sl-drx-InactivityTimer): before this timer expires, the UE remains in the active state and waits to receive the next new PSCCH/PSSCH; each time new data is received, the UE restarts the timer;
SL-DRX retransmission timer (sl-drx-RetransmissionTimer): the maximum length of time that the UE remains in the active state and waits to receive the next retransmission PSCCH/PSSCH of a specific sidelink transmission process;
SL-DRX round trip timer (sl-drx-HARQ-RTT-Timer): before this timer expires, the UE does not expect to receive retransmission data for a specific sidelink transmission process; and
SL-DRX cycle (sl-drx-Cycle): the length of time between the start of one SL-DRX duration and the start of the next SL-DRX duration.

In order to further reduce the energy consumption of the terminal, it is considered to introduce a wake-up signal (WUS) or a sleep (go to sleep) signal in the SL system to indicate that the receiving end terminal is to enter a wake-up or sleep state; however, if the WUS indicates entering the wake-up state, the transmitting end terminal will consider that the receiving end terminal is in the wake-up state during the active period; but if the receiving end terminal fails to correctly detect the WUS, the receiving end terminal will not enter the wake-up state, and will not receive the sidelink data subsequently transmitted by the transmitting end terminal, resulting in data reception failure.

How to ensure that a transmitting end terminal and the receiving end terminal have a consistent understanding of the state of the receiving end terminal, thereby ensuring the reliability of sidelink transmission, is an urgent problem that needs to be addressed.

To facilitate understanding of the technical solutions of the embodiments of the present disclosure, the technical solutions of the present disclosure are described in detail below through exemplary embodiments. The above-mentioned related technologies may be arbitrarily combined with the technical solutions of the embodiments of the present disclosure as optional solutions, and they all belong to the protection scope of the embodiments of the present disclosure. The embodiments of the present disclosure include at least part of the following contents.

FIG. 12 is a schematic interaction diagram of a wireless communication method 200 in accordance with the embodiments of the present disclosure. As shown in FIG. 12, the method 200 includes at least part of the following contents.

S210, detecting, by a first terminal, first indication information transmitted by a second terminal, the first indication information being used to indicate that the first terminal is to enter a target state; and

S220, transmitting, by the first terminal, sidelink feedback information of the first indication information to the second terminal.

In some embodiments, the target state is used to indicate whether the first terminal starts a first timer, or the target state is used to indicate whether the first terminal receives sidelink data within a first time range; where the first timer is related to a sidelink discontinuous reception (SL-DRX) duration timer (sl-drx-onDurationTimer), and the first time range is determined based on the first timer. For example, the first time range is a time range determined based on the SL-DRX duration timer (sl-drx-onDuration Timer).

In some embodiments, the first timer is related to a sidelink discontinuous reception (SL-DRX) duration timer (sl-drx-onDurationTimer), which may include: the first timer is an SL-DRX duration timer (sl-drx-onDuration Timer).

In some embodiments, the first time range is determined based on the first timer, which may include that:
a starting position of the first time range is determined according to the length of time that the SL-DRX duration timer is stared, and the length of time of the first time range is determined according to the length of time corresponding to the SL-DRX duration timer; for example, the first time range is a time range corresponding to the running period of the SL-DRX duration timer.

Optionally, the sidelink data may be sidelink data transmitted by the second terminal, or may be sidelink data transmitted by other terminals, which is not limited in the present disclosure.

Optionally, receiving the sidelink data may include, but is not limited to, receiving PSCCH or PSSCH, that is, including SCI detection.

Optionally, measurement may refer to sidelink measurement, for example, including but not limited to a sidelink reference signal receiving power (SL-RSRP) measurement and/or a sidelink received signal strength indication (SL-RSSI) measurement.

Alternatively, the first indication information may also be used to indicate whether the first terminal enters an active state or an active period, or the first indication information is used to indicate whether the first terminal starts a first timer, or the first indication information is used to indicate whether the first terminal receives sidelink data and/or performs measurement within a first time range; where the first timer is related to an SL-DRX duration timer (sl-drx-onDuration Timer), and the first time range is determined based on the first timer.

In some embodiments, the first terminal determines whether to enter an active state or an active period, or whether to start a first timer, or whether to receive sidelink data and/or perform measurement within a first time range according to the first indication information.

For example, in a case where the first indication information indicates a first value (e.g., the first value is “1” or “TRUE”) or a first state (e.g., an active state or a wake-up state), the first terminal enters the active period, or the first terminal starts the SL-DRX duration timer, or the first terminal receives the sidelink data and/or performs the measurement within the first time range; and in a case where the first indication information indicates a second value (e.g., the second value is “0” or “FALSE”) or a second state (e.g., an inactive state or a sleep state), the first terminal does not enter the active period, or the first terminal does not start the SL-DRX duration timer, or the first terminal does not receive the sidelink data and/or perform the measurement within the first time range.

In some embodiments, the target state is a first state or a second state, and the first state and the second state are different DRX states. For example, the first state is a wake-up state, and the second state is a sleep (go-to-sleep) state. For another example, the first state is an active state, and the second state is an inactive state.

In some embodiments, if the target state is a wake-up state or an active state, it means that the first terminal receives the sidelink data and/or performs the measurement within a first time range, or the first terminal needs to start the SL-DRX duration timer (sl-drx-onDurationTimer), or the first terminal enters the active period. Here, the first time range is a time range determined based on the SL-DRX duration timer (sl-drx-onDuration Timer).

In some embodiments, if the target state is a sleep state or an inactive state, it means that the first terminal does not receive the sidelink data and/or perform the measurements within a first time range, or the first terminal does not start the SL-DRX duration timer (sl-drx-onDurationTimer), or the first terminal does not enter the active period, or enters the inactive period. Here, the first time range is a time range determined based on the SL-DRX duration timer (sl-drx-onDuration Timer).

In some embodiments, the first terminal entering the wake-up state may refer to that the first terminal receives and/or measures the sidelink data within a first time range, or the first terminal entering the wake-up state may refer to that the first terminal starts the SL-DRX duration timer (sl-drx-onDurationTimer), or the first terminal entering the wake-up state may refer to that the first terminal enters the active period, where the first time range may be determined based on the running period of the SL-DRX duration timer (sl-drx-onDurationTimer), for example, the running period of the SL-DRX duration timer is the active period of the first terminal, and the first time range is an active period determined based on the running period of the SL-DRX duration timer. The first terminal entering the sleep state may refer to that the first terminal does not receive and/or measure the sidelink data within the time range determined based on the SL-DRX duration timer (sl-drx-onDurationTimer), or the first terminal entering the sleep state may refer to that the first terminal does not start the SL-DRX duration timer (sl-drx-onDurationTimer), or the first terminal entering the sleep state may refer to that the first terminal does not enter the active period.

In some embodiments, the first indication information is also called a wake-up signal or a sleep signal or an energy-saving signal. The first terminal is indicated to enter the wake-up state or the sleep state through the first indication information, thereby accomplishing the energy-saving of the first terminal.

In some embodiments, the first indication information is also called an activation signal or a non-activation signal or a deactivation signal. The first terminal is indicated to enter the active state or the inactive state through the first indication information, thereby accomplishing the energy-saving of the first terminal.

In some embodiments, the sidelink feedback information of the first indication information may be used to indicate a detection state or a reception status of the first indication information. For example, the sidelink feedback information of the first indication information may be determined according to the detection state or the reception status of the first indication information.

In some embodiments, the detection state of the first indication information may include successful detection of the first indication information (i.e., the first indication information is received and decoded successfully), no reception of the first indication information, and reception of the first indication information but decoding failure, where the latter two situations may be considered as failure to successfully detect the first indication information, or in other words, failure to detect the first indication information.

In some embodiments, the sidelink feedback information of the first indication information may be used by the second terminal to determine whether the first terminal starts the SL-DRX duration timer (sl-drx-onDurationTimer), or used by the second terminal to determine whether the first terminal enters the active period, or used by the second terminal to determine whether to transmit the sidelink data to the first terminal during the active period. Here, the active period is determined according to the SL-DRX duration timer (sl-drx-onDuration Timer).

In some embodiments, the sidelink feedback information of the first indication information may be an acknowledgement (ACK) or a negative acknowledgement (NACK).

For example, if successfully detecting the first indication information, the first terminal feeds back the ACK to the second terminal; or if unsuccessfully detecting the first indication information, the first terminal feeds back the NACK to the second terminal.

Correspondingly, the second terminal may determine the true state of the first terminal according to the sidelink feedback information of the first indication information transmitted by the first terminal, thereby avoiding the failure of sidelink data transmission caused by inconsistent understanding of the state of the first terminal between the first terminal and the second terminal.

For example, if the first indication information indicates that the first terminal is to enter the wake-up state and the first terminal feeds back the ACK, the second terminal may determine that the first terminal successfully detects the first indication information, that is, the first terminal will start the SL-DRX duration timer (sl-drx-onDurationTimer) according to the indication of the first indication information, and enter the wake-up state or the active state, then the second terminal may transmit the sidelink data to the first terminal within the running time of the SL-DRX duration timer (sl-drx-onDurationTimer); or if the first terminal feeds back the NACK, the second terminal may determine that the first terminal has not successfully detected the first indication information, that is, the first terminal will not start the SL-DRX duration timer (sl-drx-onDurationTimer), then the second terminal will not transmit the sidelink data to the first terminal within the time range corresponding to the SL-DRX duration timer (sl-drx-onDurationTimer).

Therefore, in the embodiments of the present disclosure, the first terminal may transmit the sidelink feedback information of the first indication information to the second terminal according to the detection state of the first indication information, so that the second terminal may determine whether the first terminal starts the SL-DRX duration timer (sl-drx-onDurationTimer) or whether the first terminal enters the active state (or active period) according to the sidelink feedback information, and then determine whether to transmit the sidelink data to the first terminal within the time range corresponding to the SL-DRX duration timer (sl-drx-onDuration Timer), thereby avoiding the failure of sidelink data transmission caused by inconsistent understanding of the state of the receiving end terminal between the transmitting end terminal and the receiving end terminal.

In some embodiments, the first indication information is carried through a sequence. That is, the wake-up signal may be a signal based on the sequence.

In some embodiments, the first indication information may be carried through a sidelink signal or a sidelink channel, where the sidelink signal or the sidelink channel may be an existing sidelink signal or a sidelink channel, or may be a newly added sidelink signal or a sidelink channel. For example, the first indication information may be carried through SCI or MAC CE, where the SCI may be in an existing SCI format or a newly defined SCI format.

In some embodiments, the sidelink feedback information of the first indication information is carried through a first sidelink channel.

For example, the first terminal transmits a first sidelink channel to the second terminal, where the first sidelink channel is used to carry the sidelink feedback information.

Optionally, the first sidelink channel may be a physical sidelink feedback channel (PSFCH), that is, the sidelink feedback information may be carried through the PSFCH.

In some embodiments, the first sidelink channel is transmitted in a second time domain resource, and the second time domain resource is related to a first time domain resource, where the first time domain resource is related to a time domain position of an active period of the first terminal. Optionally, the first time domain resource is determined according to a start time of the sidelink discontinuous reception (SL-DRX) duration timer (sl-drx-onDurationTimer) or a starting position of an SL-DRX cycle (the beginning of the SL DRX cycle). For example, the first time domain resource may be the start time of the SL-DRX duration timer or the starting position of the SL-DRX cycle.

In some embodiments, the second time domain resource being related to the first time domain resource may include that a starting position of the second time domain resource is related to a starting position or an ending position of the first time domain resource, or an ending position of the second time domain resource is related to the starting position or the ending position of the first time domain resource.

For example, the starting position of the second time domain resource may be determined according to the starting position or the ending position of the first time domain resource, or the ending position of the second time domain resource may be determined according to the starting position or the ending position of the first time domain resource.

It should be understood that the present disclosure does not limit the timing relationship between the second time domain resource and the first time domain resource, for example, the second time domain resource is before the first time domain resource, or the second time domain resource is after the first time domain resource.

In some embodiments, a time interval between the second time domain resource (as an exemplary example, the starting position or the ending position of the second time domain resource) and the first time domain resource (as an exemplary example, the starting position or the ending position of the first time domain resource) is greater than or equal to a first time interval. For example, the second time domain resource is before the first time domain resource, and the interval is greater than or equal to the first time interval. For another example, the second time domain resource is after the first time domain resource, and the interval is greater than or equal to the first time interval. Here, the value of the first time interval is greater than or equal to 0.

In some embodiments, the first time interval is pre-defined, pre-configured, configured by a network device, determined by the first terminal (optionally, the first terminal may further indicate the determined first time interval to the second terminal), or indicated by the second terminal to the first terminal. Here, in a case where the first time interval is indicated by the second terminal or the first terminal, the second terminal or the first terminal indicates the first time interval through SCI, MAC CE or PC5-RRC signaling.

In some embodiments, the second time domain resource is before the first time domain resource, and the first time interval may be determined according to the processing time of the first terminal or the second terminal, for example, the first time interval is greater than or equal to the processing time of the second terminal. For example, the processing time of the second terminal is determined according to the time taken by the second terminal to process the first sidelink channel, and the first time interval is greater than or equal to the processing time of the second terminal, so that the second terminal may determine whether the first terminal enters the active period according to the sidelink feedback information carried by the first sidelink channel, and then determine whether it may transmit the sidelink data to the first terminal during the active period, where the active period includes an active period determined according to the SL-DRX duration timer (sl-drx-onDuration Timer).

In some embodiments, the first indication information is transmitted in a third time domain resource, and the third time domain resource has an association relationship with the first time domain resource and/or the second time domain resource (including the starting position or the ending position). Optionally, the association relationship is pre-defined, pre-configured, configured by the network device, indicated by the first terminal to the second terminal, or indicated by the second terminal to the first terminal, that is, the first terminal and the second terminal have a consistent understanding of the association relationship.

In some embodiments, the third time domain resource having an association relationship with the first time domain resource and/or the second time domain resource may include that:
a starting position of the third time domain resource has the association relationship with the starting position or the ending position of the first time domain resource, and/or the starting position or the ending position of the second time domain resource; or
an ending position of the third time domain resource has the association relationship with the starting position or the ending position of the first time domain resource, and/or the starting position or the ending position of the second time domain resource.

For example, the starting position of the third time domain resource is determined according to the starting position of the first time domain resource and/or the starting position of the second time domain resource.

For another example, the ending position of the third time domain resource is determined according to the ending position of the first time domain resource and/or the ending position of the second time domain resource.

In some embodiments, a time interval between the third time domain resource (as an example, the starting position or the ending position of the third time domain resource) and the second time domain resource (as an example, the starting position or the ending position of the second time domain resource) is greater than or equal to a second time interval; and/or a time interval between the third time domain resource (as an example, the starting position or the ending position of the third time domain resource) and the first time domain resource (as an example, the starting position or the ending position of the first time domain resource) is greater than or equal to a third time interval.

For example, the starting position of the third time domain resource is before the starting position of the second time domain resource, and the interval between the two is greater than or equal to the second time interval.

For another example, the starting position of the third time domain resource is before the starting position of the first time domain resource, and the interval between the two is greater than or equal to the third time interval.

In some embodiments, the second time interval is pre-defined, pre-configured, configured by a network device, determined by the first terminal (optionally, the first terminal may further indicate the determined second time interval to the second terminal), or indicated by the second terminal. Here, in a case where the second time interval is indicated by the second terminal or the first terminal, the second terminal or the first terminal may indicate the second time interval through SCI, MAC CE or PC5-RRC signaling.

In some embodiments, the third time interval is pre-defined, pre-configured, configured by a network device, determined by the first terminal (optionally, the first terminal may further indicate the determined third time interval to the second terminal), or indicated by the second terminal. Here, in a case where the third time interval is indicated by the second terminal or the first terminal, the second terminal or the first terminal indicates the third time interval through SCI, MAC CE or PC5-RRC signaling.

In some embodiments, the second time interval may be determined according to the processing time of the first indication information. For example, in a case where the first indication information is carried through SCI or MAC CE, the processing time may include the detection time of PSCCH/PSSCH (that is, including the detection time of the SCI). Furthermore, the processing time may further include the preparation time of PSFCH (the sidelink feedback information is carried through the PSFCH).

In some embodiments, the second time interval may be determined, for example, based on a parameter sidelink PSFCH minimum time interval parameter (sl-MinTimeGapPSFCH), where the parameter is used to indicate a minimum time interval between a PSFCH and a PSSCH associated thereto.

It should be understood that the present disclosure does not limit the representation method of the first time domain resource, the second time domain resource and the third time domain resource. For example, absolute time representation, such as moment, may be used, or relative time representation, such as slot, symbol, or the like may be used.

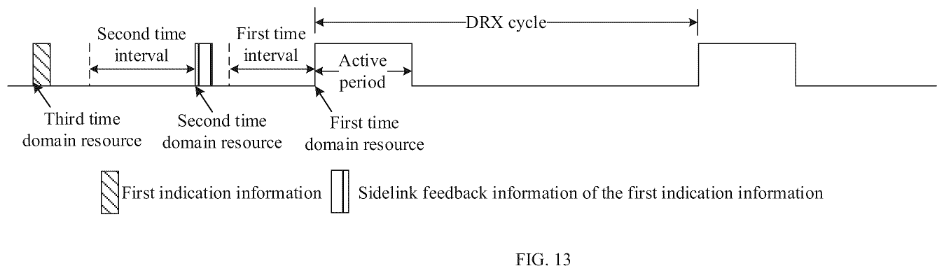

For example, as shown in FIG. 13, a DRX cycle includes an active period and an inactive period. In the example of FIG. 13, the active period is determined based on the SL-DRX duration timer (sl-drx-onDurationTimer), the start time of the SL-DRX duration timer (sl-drx-onDurationTimer) corresponds to the first time domain resource, a transmission position of the sidelink feedback information of the first indication information (i.e., the second time domain resource) is located before the first time domain resource, and the time interval between the second time domain resource and the first time domain resource is greater than the first time interval, and a transmission position of the first indication information (i.e., the third time domain resource) is located before the second time domain resource, and the time interval between the third time domain resource and the second time domain resource is greater than the second time interval.

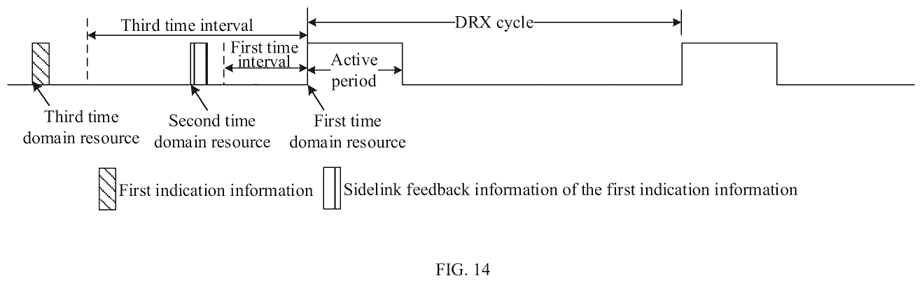

For example, as shown in FIG. 14, a DRX cycle includes an active period and an inactive period. In the example of FIG. 14, the active period is determined based on the SL-DRX duration timer (sl-drx-onDurationTimer), the start time of the SL-DRX duration timer (sl-drx-onDurationTimer) corresponds to the first time domain resource, a transmission position of the sidelink feedback information of the first indication information (i.e., the second time domain resource) is located before the first time domain resource, and the time interval between the second time domain resource and the first time domain resource is greater than the first time interval, and a transmission position of the first indication information (i.e., the third time domain resource) is located before the first time domain resource, and the time interval between the third time domain resource and the first time domain resource is greater than the third time interval.

It should be understood that FIG. 13 and FIG. 14 only illustrate the examples that the second time domain resource is located before the first time domain resource, but the present disclosure is not limited to this, and the second time domain resource may also be located after the first time domain resource.

The design of the first indication information and the sidelink feedback information is described below in conjunction with some embodiments.

Embodiment 1: the first indication information is carried through a sequence.

In some embodiments, in a case where the first indication information is a first sequence, it is used to indicate that the first terminal is to enter a first state, e.g., a wake-up state or an active state.

In some embodiments, in a case where the first indication information is a second sequence, it is used to indicate that the first terminal is to enter a second state, e.g., a sleep state or an inactive state.

In some embodiments, a transmission resource of the first indication information (or a transmission resource of the sequence) includes 2 symbols.

In some embodiments, the 2 symbols are two adjacent symbols in a slot.

In some embodiments, the 2 symbols include a second-to-last symbol and a third-to-last symbol in a slot that are available for sidelink transmission. Optionally, same data is transmitted on the 2 symbols.

Optionally, in a case where the first indication information is carried through a sequence, the sequence may be transmitted separately from other sidelink physical channels. That is, the sequence and other sidelink physical channels are not multiplexed for transmission.

Optionally, a time domain resource used to transmit the first indication information may also be used to transmit other sidelink signals or sidelink channels. The other sidelink signals or sidelink channels and the first indication information occupy a same time domain resource in the slot. For example, the first indication information occupies symbol 11 and symbol 12 in the slot (the first symbol in the slot is symbol 0, and the slot includes 14 symbols in total), and the other sidelink signals or sidelink channels also occupy the symbol 11 and the symbol 12 in the slot.

Optionally, a time domain resource used to transmit the first indication information may also be used to transmit PSFCH, or a time domain resource for transmitting PSFCH may also be used to transmit the first indication information; that is, PSFCH and the first indication information are located in a same time domain resource, and further optionally, PSFCH and the first indication information may be located in a same time domain symbol.

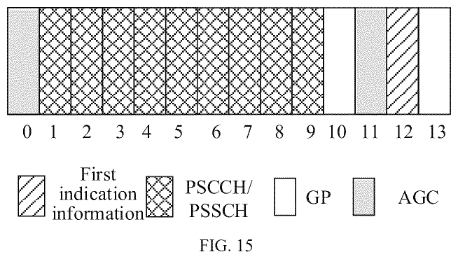

For example, as shown in FIG. 15, all symbols in a slot are symbols available for sidelink transmission, the second-to-last and the third-to-last time domain symbols in the slot are used to carry the first indication information, data transmitted on the two time domain symbols may be the same, and the first time domain symbol may be used as an AGC symbol, and the fourth-to-last time domain symbol in the slot is used as a GP symbol.

In some embodiments, a frequency domain resource of the sequence include M PRBs, where M is an integer greater than or equal to 1.

In some embodiments, the value of M is determined according to pre-defined information, pre-configured information, or network configuration information.

That is, M may be pre-defined or pre-configured, or may be configured by a network device.

In some embodiments, the sequence used to carry the first indication information may be expressed as:

$$r ( n ) = {e}^{j a n} \overline{r} ( n ) , 0 \leq n < {M}_{ZC}$$

Here,

$${M}_{ZC} = M * {N}_{sc}^{RB}$$

represents the length of the sequence r̅(n) represents a root sequence, α represents a cyclic shift, and

$${N}_{sc}^{RB}$$

represents the number of subcarriers included in an RB, for example

$${N}_{sc}^{RB} = 12 .$$

In some embodiments, the sequence used to carry the first indication information is related to at least one of the following pieces of information. For example, the sequence used to carry the first indication information may be determined according to at least one of the following pieces of information:
a pre-configuration parameter, a parameter configured by a network device, identification information of the first terminal, identification information of the second terminal, group identification information of a communication group to which the first terminal belongs, group identification information of a communication group to which the second terminal belongs, content indicated by the first indication information, slot information corresponding to a transmission resource of the first indication information, symbol information corresponding to the transmission resource of the first indication information, a total number of subcarriers included in M PRBs, a number of subcarriers included in one PRB, or a length of the sequence.

In some embodiments, the identification information of the first terminal may be determined according to source identification information carried in SCI transmitted by the first terminal to the second terminal, or may also be determined based on destination identification information carried in SCI transmitted by the second terminal to the first terminal. The sequence carrying the first indication information is determined according to the identification information of the first terminal, so that the first indication information transmitted to different terminals corresponds to different sequences, thereby avoiding mutual interference.

In some embodiments, the identification information of the second terminal may be determined according to source identification information carried in SCI transmitted by the second terminal to the first terminal, or may also be determined based on destination identification information carried in SCI transmitted by the first terminal to the second terminal. The sequence carrying the first indication information is determined according to the identification information of the second terminal, so that the first indication information transmitted by different terminals corresponds to different sequences, thereby avoiding mutual interference.

In some embodiments, the group identification information of the communication group to which the first terminal belongs may be determined according to destination identification information carried in SCI transmitted by the second terminal to the communication group to which the first terminal belongs. The sequence carrying the first indication information is determined according to the group identification information of the communication group to which the first terminal belongs, so that the first indication information transmitted to different terminal groups corresponds to different sequences, thereby avoiding mutual interference.

In some embodiments, the group identification information of the communication group to which the second terminal belongs may be determined according to destination identification information carried in SCI transmitted by the first terminal to the communication group to which the second terminal belongs. The sequence carrying the first indication information is determined according to the group identification information of the communication group to which the second terminal belongs, so that the first indication information transmitted by different terminal groups corresponds to different sequences, thereby avoiding mutual interference.

In some embodiments, the content indicated by the first indication information may include that first indication information is used to indicate a first state (e.g., a wake-up state or an active state) or a second state (e.g., a sleep state or an inactive state), and the second terminal may carry different indication contents through different sequences. Correspondingly, the first terminal may interpret different sequences as different indication contents. For example, the second terminal indicates the first state through the first sequence. In this case, when receiving the first sequence, the first terminal may determine that the second terminal indicates that the first terminal is to enter the first state. For another example, the second terminal indicates the second state through the second sequence. In this case, when receiving the second sequence, the first terminal may determine that the second terminal indicates that the first terminal is to enter the second state. The sequence carrying the first indication information determines implementation of code division multiplexing according to the content indicated by the first indication information, thereby improving transmission efficiency.

In some embodiments, the slot information corresponding to the transmission resource of the first indication information may be determined based on a slot where the first terminal detects the first indication information. For example, the slot information corresponding to the transmission resource of the first indication information may be a serial number of the slot where the first terminal detects the first indication information. The sequence carrying the first indication information is determined according to the slot information corresponding to the transmission resource of the first indication information, so as to accomplish randomization of interference between sequences to reduce transmission interference.

In some embodiments, the symbol information corresponding to the transmission resource of the first indication information may be determined based on a symbol where the first terminal detects the first indication information. Optionally, if the time domain resource of the first indication information includes 2 time domain symbols, the symbol information is determined based on the second or first time domain symbol in the 2 time domain symbols. That is, the symbol corresponding to the transmission resource of the first indication information may be the second time domain symbol or the first time domain symbol in the two time domain resources. The sequence carrying the first indication information is determined according to the symbol information corresponding to the transmission resource of the first indication information, so as to accomplish interference randomization between sequences to reduce transmission interference.

In some embodiments, the M PRBs may be PRBs occupied by the sequence, that is, a corresponding sequence may be generated according to the frequency domain resource occupied by the sequence. For example, a corresponding sequence may be generated according to the number of subcarriers included in the frequency domain resource occupied by the sequence. For example, different sequences may be generated for different numbers of subcarriers.

In some embodiments, the number of subcarriers included in one PRB may refer to the number of subcarriers included in each PRB of the M PRBs occupied by the sequence. For example, a first sequence may be generated according to the number of subcarriers included in one PRB, and sequences mapped on different PRBs may be sequences processed according to the first sequence. For example, a cyclic shift process is performed on the first sequence, and the processed first sequence is mapped to each corresponding PRB.

In some embodiments, the length of the sequence may be a pre-defined length, or a pre-configured length, or a length configured by a network device, or a length indicated by the second terminal.

In some embodiments, the root sequence of the sequence used to carry the first indication information is related to at least one of the following pieces of information, or is determined according to at least one of the following pieces of information:
a pre-configuration parameter, a parameter configured by a network device, identification information of the first terminal, identification information of the second terminal, group identification information of a communication group to which the first terminal belongs, group identification information of a communication group to which the second terminal belongs, content indicated by the first indication information, slot information corresponding to a transmission resource of the first indication information, symbol information corresponding to the transmission resource of the first indication information, a total number of subcarriers included in M PRBs, a number of subcarriers included in one PRB, or a length of the sequence.

Here, the meaning of the above information refers to the relevant description of the above embodiments. The implementation of determining the root sequence according to the above information is similar to the implementation of determining the sequence according to the above information, which will not be described in detail here for the sake of brevity.

In some embodiments, the cyclic shift of the sequence used to carry the first indication information is related to at least one of the following pieces of information, or is determined according to at least one of the following pieces of information:
a pre-configuration parameter, a parameter configured by a network device, identification information of the first terminal, identification information of the second terminal, group identification information of a communication group to which the first terminal belongs, group identification information of a communication group to which the second terminal belongs, content indicated by the first indication information, slot information corresponding to a transmission resource of the first indication information, symbol information corresponding to the transmission resource of the first indication information, a total number of subcarriers included in M PRBs, a number of subcarriers included in one PRB, or a length of the sequence.

Here, the meaning of the above information refers to the relevant description of the above embodiments. The implementation of determining the cyclic shift according to the above information is similar to the implementation of determining the sequence according to the above information, which will not be described in detail here for the sake of brevity.

In some embodiments of the present disclosure, the transmission resource of the first indication information are pre-configured, configured by a network device, or indicated by the second terminal to the first terminal, or indicated by the first terminal to the second terminal, or determined according to a preset rule, that is, the first terminal and the second terminal have a consistent understanding of the transmission resource of the first indication information. Here, in a case where the transmission resource of the first indication information is indicated by the second terminal, the second terminal indicates the transmission resource of the first indication information through SCI, MAC CE or PC5-RRC signaling; in a case where the transmission resource of the first indication information is indicated by the first terminal, the first terminal indicates the transmission resource of the first indication information through SCI, MAC CE or PC5-RRC signaling.

In some embodiments, the second terminal may determine the transmission resource of the first indication information according to the first information. Correspondingly, the first terminal may also determine the transmission resource of the first indication information according to the first information. That is, the first terminal and the second terminal have a consistent understanding of the transmission resource of the first indication information.

In some embodiments, the transmission resource of the first indication information is related to the first information. For example, the transmission resource of the first indication information is determined according to the first information, where the first information includes at least one of the following pieces of information:
a first time domain resource;
a second time domain resource;
identification information of the second terminal;
identification information of the first terminal;
content indicated by the first indication information;
a number of PRBs available for transmitting the first indication information; or
a number of cyclic shift values or cyclic shift pairs for code division multiplexing within a same frequency domain resource.

Here, the implementation of the first time domain resource, the second time domain resource, the identification information of the second terminal, the identification information of the first terminal, and the content indicated by the first indication information refers to the relevant description of the foregoing embodiments, which will not be described in detail here for the sake of brevity. In some embodiments, the transmission resource of the first indication information may include at least one of the following:
a time domain resource of the first indication information (i.e., the third time domain resource), a frequency domain resource of the first indication information (e.g., a PRB where the first indication information is located), or a code domain resource of the first indication information.

In some embodiments, the time domain resource of the first indication information (i.e., the third time domain resource) may be determined according to the first time domain resource and/or the second time domain resource, or the time domain resource of the first indication information has an association relationship with the first time domain resource and/or the second time domain resource.

In some embodiments, a time interval between the third time domain resource and the first time domain resource is greater than or equal to a third time interval. Here, the third time domain resource may be located before the first time domain resource, or located after the first time domain resource.

For example, the third time domain resource is located before the first time domain resource, and the time interval between the third time domain resource and the first time domain resource is greater than or equal to the third time interval.

For another example, the third time domain resource is located before the first time domain resource, the time interval between the third time domain resource and the first time domain resource is greater than or equal to the third time interval, and the third time domain resource is an available transmission resource closest to the first time domain resource.

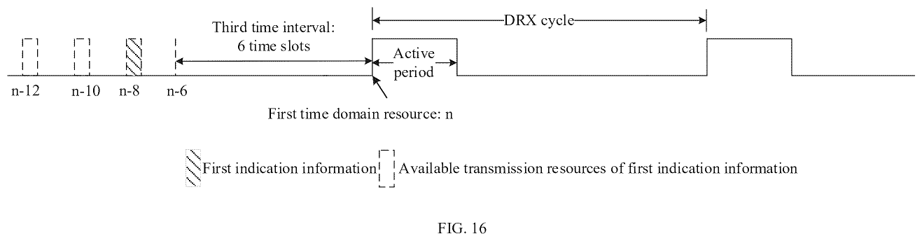

For example, as shown in FIG. 16, the first time domain resource is slot n, and the third time interval is 6 slots, then the third time domain resource is located before slot n−6. If available transmission resources of the first indication information before slot n−6 include slot n−8, slot n−10 and slot n−12, etc., then the available transmission resource located before slot n−6 and closest to the first time domain resource is located in slot n−8, that is, the third time domain resource is slot n−8.

In some other embodiments, the second time domain resource and the third time domain resource have an association relationship, and the first terminal may know the second time domain resource in advance. For example, the second time domain resource may be a periodic sidelink transmission resource pre-configured or configured by the network device, then the first terminal may determine the third time domain resource according to the second time domain resource in combination with the association relationship.

In some embodiments, a time interval between the third time domain resource and the second time domain resource is greater than or equal to a second time interval.

For example, the third time domain resource is located before the second time domain resource, and the time interval between the third time domain resource and the second time domain resource is greater than or equal to the second time interval.

For another example, the third time domain resource is located before the second time domain resource, the time interval between the third time domain resource and the second time domain resource is greater than or equal to the second time interval, and the third time domain resource is an available transmission resource closest to the second time domain resource.

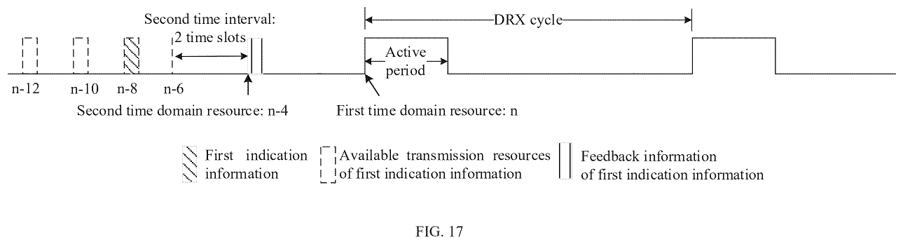

For example, as shown in FIG. 17, the first time domain resource is slot n, the second time domain resource is slot n−4, and the second time interval is 2 slots, then the time domain resource of the first indication information is located before slot n−6. If available transmission resources of the first indication information before slot n−6 include slot n−8, slot n−10, and slot n−12, etc., then the available transmission resource located before slot n−6 and closest to the second time domain resource is located in slot n−8, that is, the time domain resource of the first indication information is slot n−8.

In some embodiments, the content indicated by the first indication information may include that the first indication information is used to indicate a first state or a second state, where the different states correspond to different code domain resources. For example, in a case where the first indication information is carried through a sequence, the content indicated by the first indication information corresponds to different code domain resources of the sequence, for example, corresponds to different cyclic shift values. For example, in a case where the first indication information indicates that the first terminal is to enter the first state, the corresponding cyclic shift value is 0; and in a case where the first indication information indicates that the first terminal is to enter the second state, the corresponding cyclic shift value is 6. In this way, the first terminal may determine the state indicated by the first indication information according to the cyclic shift value of the sequence carrying the first indication information.

In some embodiments, the total number of PRBs available for transmitting the first indication information may refer to a number of PRBs available for transmitting the first indication information in one symbol. For example, the number of PRBs included in the resource pool is 100, and the total number of PRBs in the resource pool that are available for transmitting the first indication information determined according to pre-configuration information (e.g., indicating available PRB information of the first indication information in the form of a bit map) is 40, that is, the number of PRBs that are available for transmitting the first indication information in one symbol is 40. If the size of the frequency domain resource of the first indication information is 2 PRBs (i.e., M=2), then the number of pieces of first indication information for frequency division multiplexing in one symbol is 20.

In some embodiments, the identification information of the second terminal and/or the identification information of the first terminal may be used to determine the transmission resource of the first indication information.

For example, a PRB set available for transmitting the first indication information and the number of sequences for code division multiplexing in a same frequency domain are determined according to the pre-configuration information. In one slot, transmission resources available for transmitting first indication information are indexed in a manner of the frequency domain first followed by the code domain, and then index information of the transmission resource corresponding to the first indication information is determined according to the identification information of the second terminal and/or the identification information of the first terminal.

In some embodiments, the identification information of the second terminal and/or the identification information of the first terminal may be used to determine code domain resource of the first indication information, for example, to determine a cyclic shift value of a sequence carrying the first indication information. The cyclic shift value of the sequence carrying the first indication information is determined according to the identification information of the first terminal, which may enable the first indication information transmitted to different terminals to correspond to different sequences, thereby avoiding mutual interference. The cyclic shift value of the sequence carrying the first indication information is determined according to the identification information of the second terminal, which may enable the first indication information transmitted by different terminals to correspond to different sequences, thereby avoiding mutual interference.

In some embodiments, the number of cyclic shift values or cyclic shift pairs for code division multiplexing in the same frequency domain resource may be used to determine cyclic shifts of a sequence for generating the first indication information, where one cyclic shift pair includes two cyclic shift values.

For example, in a case where the number of cyclic shift values for code division multiplexing in the same frequency domain resource is 2, or the number of cyclic shift pairs for code division multiplexing in the same frequency domain resource is 1, the second terminal may determine the corresponding cyclic shift value according to the content indicated by the first indication information, where in a case where the first indication information indicates different states, different states correspond to different cyclic shift values. Further, the sequence generated according to this pair of cyclic shift values may be multiplexed on the same frequency domain resource.

For example, in a case where the number of cyclic shift pairs for code division multiplexing in the same frequency domain resource is 2, the second terminal may determine the corresponding cyclic shift pair according to the content indicated by the first indication information, where in a case where the first indication information indicates different states, different states correspond to different cyclic shift pairs. The sequence generated according to these two cyclic shift value pairs may be multiplexed on the same frequency domain resource.

For example, the first indication information occupies 1 (i.e., M=1) PRB, then in the 1 PRB, multiple pieces of first indication information may be supported by code division multiplexing to multiplex the same PRB, but correspond to different cyclic shift pairs; for example, one piece of first indication information may correspond to one cyclic shift pair, such as cyclic shift pair {0, 6}, where first indication information based on the cyclic shift value of 0 represents the first state, and first indication information based on the cyclic shift value of 6 represents the second state; the number of cyclic shift pairs through code division multiplexing may be configured to be 2, such as supporting cyclic shift pair {0, 6} and cyclic shift pair {3, 9}, and pieces of first indication information generated by these two groups of cyclic shift pairs may multiplex the same frequency domain resource.

In some embodiments of the present disclosure, the transmission resource of the first sidelink channel is pre-configured, configured by a network device, or indicated by the second terminal to the first terminal, or indicated by the first terminal to the second terminal, or determined according to a preset rule, that is, the first terminal and the second terminal have a consistent understanding of the transmission resource of the first indication information. Here, in a case where the transmission resource of the first sidelink channel is indicated by the second terminal to the first terminal, the second terminal may indicate the transmission resource of the first sidelink channel through SCI, MAC CE or PC5-RRC signaling; and in a case where the transmission resource of the first sidelink channel is indicated by the first terminal to the second terminal, the first terminal may indicate the transmission resource of the first sidelink channel through SCI, MAC CE or PC5-RRC signaling.

In some embodiments, the transmission resource of the first sidelink channel is determined based on transmission resources of a channel, signal or sequence carrying the first indication information. For example, if there is an association relationship between the transmission resource of the first sidelink channel and the transmission resources of the channel, signal or sequence carrying the first indication information, the second terminal may determine the transmission resource of the first sidelink channel according to the transmission resources of the channel, signal or sequence carrying the first indication information and the association relationship. Correspondingly, the first indication information may determine the transmission resource of the first sidelink channel according to the detected transmission resource of the first indication information in combination with the association relationship. Optionally, the association relationship may be pre-defined, pre-configured, configured by a network device, indicated by the second terminal to the first terminal, or indicated by the first terminal to the second terminal.

In some embodiments, the transmission resource of the first sidelink channel is related to second information, for example, the transmission resource of the first sidelink channel is determined according to the second information, where the second information includes at least one of the following pieces of information:
identification information of the first terminal;
identification information of the second terminal;
slot information corresponding to a transmission resource of the first indication information;
symbol information corresponding to the transmission resource of the first indication information;
a first time domain resource;
starting frequency domain position information corresponding to the transmission resource of the first indication information;
frequency domain length information corresponding to the transmission resource of the first indication information;
a number of PRBs available for transmitting the first indication information; or
a number of cyclic shift values or cyclic shift pairs for code division multiplexing within a same frequency domain resource.

Here, the implementation of each piece of information in the second information refers to the relevant description of the foregoing embodiments, which will not be described in detail here for the sake of brevity.

In some embodiments, the transmission resource of the first sidelink channel may include at least one of the following:
a time domain resource of the first sidelink channel (i.e., the second time domain resource), a frequency domain resource of the first sidelink channel (e.g., a PRB where the first sidelink channel is located), or a code domain resource of the first sidelink channel.

In some embodiments, the transmission resource of the first sidelink channel is determined according to the first time domain resource.

For example, the second time domain resource and the first time domain resource have an association relationship, and the first terminal may determine the second time domain resource according to the first time domain resource in combination with the association relationship.

In some embodiments, a time interval between the second time domain resource and the first time domain resource is greater than or equal to a first time interval. Here, the second time domain resource may be located before the first time domain resource, or may be located after the first time domain resource.

In an embodiment, the second time domain resource is located before the first time domain resource, and the time interval between the second time domain resource and the first time domain resource is greater than or equal to the first time interval.

In an embodiment, the second time domain resource is located before the first time domain resource, the time interval between the second time domain resource and the first time domain resource is greater than or equal to the first time interval, and the second time domain resource is an available transmission resource closest to the first time domain resource.

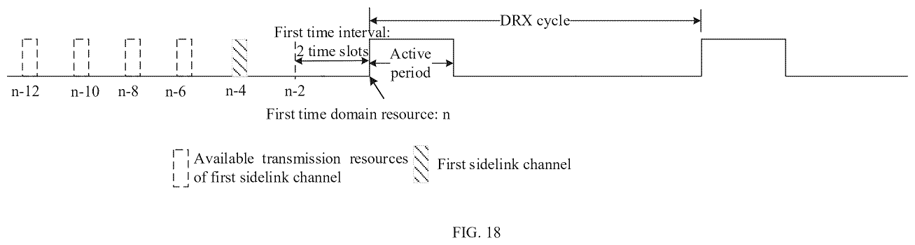

For example, as shown in FIG. 18, the first time domain resource is slot n, the second time domain resource is slot n−4, and the second time interval is 2 slots, then the time domain resource of the first indication information is located before slot n−6. If available transmission resources of the first indication information before slot n−6 include slot n−8, slot n−10, and slot n−12, etc., then the available transmission resource located before slot n−6 and closest to the first time domain resource is located in slot n−4, that is, the time domain resource of the first sidelink channel is slot n−4.

In some embodiments, the time domain resource (i.e., the second time domain resource) of the first sidelink channel is determined according to the third time domain resource.

Optionally, the third time domain resource may be determined according to slot information corresponding to the transmission resource of the first indication information and/or symbol information corresponding to the transmission resource of the first indication information.

For example, the third time domain resource is a slot where the first indication information detected by the first terminal is located, or the third time domain resource is a symbol where the first indication information detected by the first terminal is located.

In some embodiments, the second time domain resource and the third time domain resource have an association relationship, and the first terminal may determine the second time domain resource according to the third time domain resource in combination with the association relationship.

In some embodiments, a time interval between the second time domain resource and the third time domain resource is greater than or equal to a second time interval.

For example, the second time domain resource is after the third time domain resource, and the time interval between the second time domain resource and the third time domain resource is greater than or equal to the second time interval.

For another example, the second time domain resource is after the third time domain resource, the time interval between the second time domain resource and the third time domain resource is greater than or equal to the second time interval, and the second time domain resource is an available transmission resource closest to the third time domain resource.

In some embodiments, the frequency domain resource and/or the code domain resource corresponding to the transmission resource of the first sidelink channel may be determined based on the identification information of the first terminal and/or the identification information of the second terminal.

For example, a PRB set available for transmitting the first sidelink channel is determined according to pre-configuration information, and a PRB corresponding to the transmission resource of the first sidelink channel is determined according to the identification information of the second terminal and/or the identification information of the first terminal.

For another example, the first sidelink channel is carried through a sequence, and the identification information of the first terminal and/or the identification information of the second terminal may be used to determine a cyclic shift value of the sequence carrying the first sidelink channel. For example, different sidelink feedback information (ACK or NACK) corresponds to different cyclic shift values.

In some embodiments, the total number of PRBs available for transmitting the first sidelink channel may refer to a number of PRBs available for transmitting the first sidelink channel in one symbol. For example, the number of PRBs included in a resource pool is 100, and the total number of PRBs in the resource pool available for transmitting the first sidelink channel determined according to pre-configuration information (for example, indicating available PRB information of the first sidelink channel in the form of a bit map) is 20, that is, the number of PRBs available for transmitting the first sidelink channel in one symbol is 20. If the size of the frequency domain resource of the first sidelink channel is 1 PRB, the number of first sidelink channels capable of frequency division multiplexing in one symbol is 20.

In some embodiments, starting frequency domain position information corresponding to the transmission resource of the first indication information and a starting frequency domain position corresponding to the transmission resource of the first sidelink channel have an association relationship. In this case, the first terminal or the second terminal may determine the starting frequency domain position corresponding to the transmission resource of the first sidelink channel according to a starting frequency domain position corresponding to the transmission resource of the first indication information in combination with the association relationship.

For example, the starting frequency domain position information corresponding to the transmission resource of the first indication information and the starting frequency domain position corresponding to the transmission resource of the first sidelink channel having an association relationship may include that:
the starting frequency domain position information corresponding to the transmission resource of the first sidelink channel may be determined based on a PRB index or subchannel index corresponding to the starting frequency domain position corresponding to the transmission resource of the first indication information, for example, the starting frequency domain position information corresponding to the transmission resource of the first sidelink channel may be the PRB index or the subchannel index corresponding to the starting frequency domain position corresponding to the transmission resource of the first indication information.

In some embodiments, starting frequency domain position information corresponding to the transmission resource of the first sidelink channel may be determined based on a starting frequency domain position and a frequency domain length corresponding to the transmission resource of the first indication information. For example, the starting frequency domain position corresponding to the transmission resource of the first sidelink channel is a position where the starting frequency domain position corresponding to the transmission resource of the first indication information is offset by the frequency domain length.

In some embodiments, a frequency domain length corresponding to the transmission resource of the first sidelink channel may be determined based on a frequency domain length corresponding to the transmission resource of the first indication information. For example, the frequency domain length corresponding to the transmission resource of the first sidelink channel and the frequency domain length corresponding to the transmission resource of the first indication information have an association relationship.

In some embodiments, the sidelink feedback information may also be carried through a sequence. Here, the design for the sequence carrying the sidelink feedback information may refer to the design for the sequence carrying the first indication information, which will not be described in detail here for the sake of brevity.

In some embodiments, the number of cyclic shift values or cyclic shift pairs for code division multiplexing in the same frequency domain resource may be used to determine cyclic shifts of a sequence for generating the sidelink feedback information, where one cyclic shift pair includes two cyclic shift values.

For example, in a case where the number of cyclic shift values for code division multiplexing in the same frequency domain resource is 2, or in a case where the number of cyclic shift pairs for code division multiplexing in the same frequency domain resource is 1, the first terminal may determine the corresponding cyclic shift value according to content fed back by the sidelink feedback information, where in a case where the sidelink feedback information feeds back ACK or NACK, ACK and NACK correspond to different cyclic shift values. A sequence generated according to this pair of cyclic shift values may be multiplexed on the same frequency domain resource.

For example, in a case where the number of cyclic shift pairs for code division multiplexing in the same frequency domain resource is 2, the first terminal may determine the corresponding cyclic shift value according to content fed back by the sidelink feedback information, where in a case where the sidelink feedback information feeds back ACK or NACK, ACK and NACK correspond to different cyclic shift pairs. A sequence generated according to these two cyclic shift value pairs may be multiplexed on the same frequency domain resource.

For example, the first sidelink channel is PSFCH, which carries the sidelink feedback information through a sequence. One PSFCH occupies one PRB, then in this one PRB, multiple PSFCHs may be supported by code division multiplexing to multiplex the same PRB, but the multiple PSFCHs correspond to different cyclic shift pairs. For example, one PSFCH may correspond to one cyclic shift pair, such as cyclic shift pair {0, 6}, where a PSFCH generated based on a cyclic shift value of 0 represents ACK, and a PSFCH generated based on a cyclic shift value of 6 represents NACK. Alternatively, the number of cyclic shift pairs through code division multiplexing may be configured to be 2, such as supporting cyclic shift pairs {0, 6} and cyclic shift pairs {3, 9}, and PSFCHs generated by these two groups of cyclic shift pairs may multiplex the same frequency domain resource.

Embodiment 2: the first indication information is carried through SCI.

In Embodiment 2, the transmission resource of the first indication information and the transmission resource of the first sidelink channel may be determined in a similar manner to that in Embodiment 1, which will not be described in detail here for the sake of brevity.

In some embodiments, the first indication information may be carried through an information field in SCI, such as carrying the first indication information through an existing information field, or a new information field may be added to carry the first indication information. For example, different values of the information field in the SCI are used to indicate that the first terminal is to enter different states. For example, in a case where the information field takes a first value, it indicates that the first terminal is to enter a first state (such as a wake-up state or an active state); and in a case where the information field takes a second value, it indicates that the first terminal is to enter a second state (such as a sleep state or an inactive state).

In some embodiments, the first indication information is carried in the format of SCI. For example, SCI of different formats may be used to indicate that the first terminal is to enter different states.

For example, in a case where the SCI is in a first format, it is used to indicate that the first terminal is to enter a first state (such as a wake-up state or an active state); and in a case where the SCI is in a second format, it is used to indicate that the first terminal is to enter a second state (such as a sleep state or an inactive state). Here, the first format and the second format are different.

Optionally, a correspondence relationship between the format of the SCI and the indicated state is pre-defined, or configured by a network device, or indicated by the second terminal, or indicated by the first terminal to the second terminal. That is, the first terminal and the second terminal have a consistent understanding of the format of the SCI and the indicated state. In a case where the correspondence relationship is indicated by the first terminal or the second terminal, the first terminal or the second terminal may indicate the correspondence relationship through SCI, MAC CE or PC5-RRC signaling.

In some embodiments, the first indication information is carried through a scrambling code sequence of SCI. For example, the first terminal may be indicated to enter different states by using SCI generated based on different scrambling code sequences.

For example, in a case where the SCI is generated by a first scrambling code sequence, it is used to indicate that the first terminal is to enter a first state (such as a wake-up state or an active state); and in a case where the SCI is generated by a second scrambling code sequence, it is used to indicate that the first terminal is to enter a second state (such as a sleep state or an inactive state). Here, the first scrambling code sequence and the second scrambling code sequence are different.

Optionally, a correspondence relationship between the scrambling code sequence of the SCI and the indicated state is pre-defined, or configured by a network device, or indicated by the second terminal, or indicated by the first terminal to the second terminal. That is, the first terminal and the second terminal have a consistent understanding of the scrambling code sequence and the indicated state of the SCI. In a case where the correspondence relationship is indicated by the first terminal or the second terminal, the first terminal or the second terminal may indicate the correspondence relationship through SCI, MAC CE or PC5-RRC signaling.

In some implementations, a sequence of information bits a₀, a₁, a₂, a₃, . . . , a_{A-1} of the SCI after adding a CRC sequence p₀, p₁, p₂, p₃, . . . , p_{L-1} is b₀, b₁, b₂, b₃, . . . , b_{K-1}, where:

$${b}_{k} = {a}_{k} where k = 0 , 1 , 2 , … , A - 1 ;$$

$${b}_{k} = {p}_{k - A} where k = A , A + 1 , A + 2 , … , A + L - 1 ;$$

where K=A+L, A represents a length of the information bits of the SCI, and L=24 represents a length of the CRC sequence.

Bits corresponding to the CRC sequence in b₀, b₁, b₂, b₃, . . . , b_{K-1} are scrambled with a scrambling sequence x₀, x₁, . . . , x_{B-1}, where if B=L, the bits corresponding to the CRC sequence in b₀, b₁, b₂, b₃, . . . , b_{K-1} are scrambled with the scrambling sequence; if B<L, the last B bits of the CRC sequence in b₀, b₁, b₂, b₃, . . . , b_{K-1} are scrambled with the scrambling sequence. Taking B=L=24 as an example, a scrambled sequence c₀, c₁, c₂, c₃, . . . , c_{A+23} is obtained, where:

$${c}_{k} = {b}_{k} where k = 0 , 1 , 2 , … , A - 1 ;$$

$${c}_{k} = ( {b}_{k} + {x}_{k} ) mod 2 where k = A , A + 1 , A + 2 , … , A + 23 .$$

In this way, in a case where the first indication information is carried through a sequence, different scrambling code sequences xₖ may be used for scrambling to indicate different states, as shown in Table 1, using different sequences xₖ to indicate different states.

TABLE 1

| x₀, x₁, . . . , x₂₃ | State |
|---|---|
| 0, 0, 0, 0, 0, 0, 0, 0, 0, 0, 0, 0, | Second state |
| 0, 0, 0, 0, 0, 0, 0, 0, 0, 0, 0, 0 | (such as sleep state |
| | or inactive state) |
| 1, 1, 1, 1, 1, 1, 1, 1, 1, 1, 1, 1, | First state |
| 1, 1, 1, 1, 1, 1, 1, 1, 1, 1, 1, 1 | (such as wake-up state |
| | or active state) |

In some other implementations, the first indication information being carried through a scrambling sequence of the SCI may include that:
different initial values of the scrambling code sequence correspond to different states indicated by the first indication information, that is, in a case where the first terminal is indicated to enter a different state, the SCI may be scrambled by using the scrambling code sequence with a different initial value.

For example, a bit sequence d(0), . . . , d(M_{bit}−1) of the SCI after channel coding needs to be scrambled, and the scrambling sequence is c(0), . . . , c(M_{bit}−1), for example, the scrambling according to the following formula:

$$\tilde{b} ( i ) = ( b ( i ) + c ( i ) ) mod 2$$

Here, an initial value of a scrambling code sequence generator is determined by a third value or a fourth value; in a case where cᵢₙᵢₜ is determined by the third value (e.g., 1), it means that the first terminal is to enter the first state (such as the wake-up state or the active state); and in a case where cᵢₙᵢₜ is determined by the fourth value (e.g., 0), it means that the first terminal is to enter the second state (such as the sleep state or the inactive state).

In some embodiments, the first indication information is carried through first-stage SCI. In this case, the S220 may include:
in response to successfully detecting the first-stage SCI, feeding back, by the first terminal, ACK information to the second terminal; or
in response to unsuccessfully detecting the first-stage SCI, feeding back, by the first terminal, NACK information to the second terminal.

For example, in response to obtaining the transmission resource of the first indication information, the first terminal may detect the first-stage SCI on the determined transmission resource. If successfully detecting the first-stage SCI, the first terminal will feed back ACK; if not receiving the first-stage SCI or the first-stage SCI decoding fails, the first terminal will feed back NACK.

In some embodiments, the first indication information is carried through second-order SCI.

In this case, the S220 may include:
in response to successfully detecting the second-order SCI, feeding back, by the first terminal, ACK information to the second terminal; or
in response to successfully detecting first-stage SCI but unsuccessfully detecting the second-order SCI, feeding back, by the first terminal, NACK information to the second terminal; or
in response to unsuccessfully detecting the first-stage SCI, feeding back, by the first terminal, the NACK information to the second terminal, or not transmitting, by the first terminal, the sidelink feedback information.

For example, in response to obtaining the transmission resource of the first indication information, the first terminal may detect the first-stage SCI on the determined transmission resource. If not successfully detecting the first-stage SCI, the first terminal will feed back NACK; if successfully detecting first-stage SCI but unsuccessfully detecting the second-order SCI, the first terminal will feed back NACK; or if successfully detecting the second-order SCI, the first terminal will feed back ACK.

For another example, in a case where the first terminal cannot accurately obtain the transmission resource of the first indication information, if the first terminal unsuccessfully detects the first-stage SCI, the first terminal may not transmit the sidelink feedback information.

In some embodiments, if the second terminal receives the first sidelink channel transmitted by the first terminal and the sidelink feedback information in the first sidelink channel is ACK, the second terminal may determine that the first terminal correctly receives the first indication information. Furthermore, the second terminal may decide whether to transmit sidelink data to the first terminal within the time range determined by the SL-DRX duration timer (sl-drx-onDurationTimer) according to the state indicated by the first indication information. For example, if the first indication information indicates that the first terminal is to enter the wake-up state, the second terminal may transmit the sidelink data to the first terminal within the time range determined by the SL-DRX duration timer (sl-drx-onDurationTimer); or if the first indication information indicates that the first terminal to enter the sleep state, the second terminal does not transmit the sidelink data to the first terminal within the time range determined by the SL-DRX duration timer (sl-drx-onDuration Timer).

In some embodiments, if the second terminal does not receive the first sidelink channel, or receives the first sidelink channel but the sidelink feedback information in the first sidelink channel is NACK, the second terminal may determine that the first terminal has not correctly received the first indication information. The second terminal may then determine that the first terminal will not enter the wake-up state or the active state, or determine that the first terminal will not start the SL-DRX duration timer (sl-drx-onDurationTimer), and may decide not to transmit the sidelink data to the first terminal within the time range determined by the SL-DRX duration timer (sl-drx-onDuration Timer).

In summary, in the embodiments of the present disclosure, by introducing the sidelink feedback mechanism of the wake-up signal, the transmitting end terminal may be informed whether the receiving end terminal has correctly received the wake-up signal and whether the receiving end terminal has entered the wake-up state, thereby avoiding the problem that the receiving end terminal cannot correctly receive the sidelink data due to the fact that the receiving end terminal does not enter the wake-up state in accordance with the instructions of the transmitting end terminal.

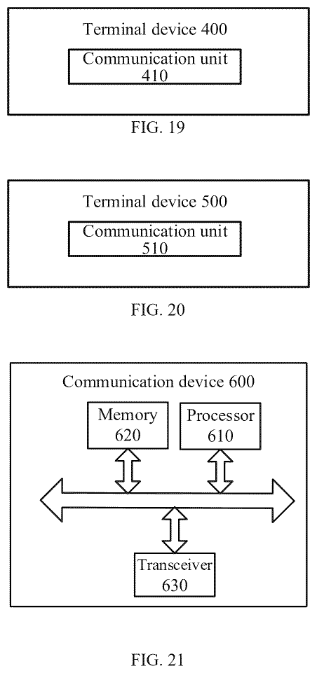

The above, in combination with FIGS. 12 to 18, describes in detail the method embodiments of the present disclosure. The following, in combination with FIGS. 19 to 23, describes in detail the device embodiments of the present disclosure. It should be understood that the device embodiments and the method embodiments correspond to each other, and similar descriptions may refer to the method embodiments.

FIG. 19 shows a schematic block diagram of a terminal device 400 in accordance with some embodiments of the present disclosure. As shown in FIG. 19, the terminal device 400 includes:
a communication unit 410, configured to detect first indication information transmitted by a second terminal, the first indication information being used to indicate that the terminal device is to enter a target state; the target state being used to indicate whether the terminal device starts a first timer, or the target state being used to indicate whether the terminal device receives sidelink data within a first time range; where the first timer is related to a sidelink discontinuous reception (SL-DRX) duration timer, and the first time range is determined based on the first timer; and
transmit sidelink feedback information of the first indication information to the second terminal.

In some embodiments, the target state is a first state or a second state, and the first state and the second state are different discontinuous reception (DRX) states.

In some embodiments, the first state is a wake-up state or an active state, and the second state is a sleep state or an inactive state.

In some embodiments, the target state being used to indicate whether the terminal device starts the first timer, or the target state being used to indicate whether the terminal device receives the sidelink data within the first time range, includes that:
in response to that the target state is a wake-up state or an active state, the terminal device starts the first timer, or the terminal device receives the sidelink data within the first time range; or
in response to that the target state is a sleep state or an inactive state, the terminal device does not start the first timer, or the terminal device does not receive the sidelink data within the first time range.

In some embodiments, the sidelink feedback information is carried through a first sidelink channel.

In some embodiments, the first sidelink channel is transmitted in a second time domain resource, the second time domain resource is related to a first time domain resource, and the first time domain resource is determined according to a start time of the SL-DRX duration timer or a starting position of an SL-DRX cycle.

In some embodiments, the second time domain resource is before the first time domain resource, or the second time domain resource is after the first time domain resource.

In some embodiments, a time interval between the second time domain resource and the first time domain resource is greater than or equal to a first time interval.

In some embodiments, the first time interval is pre-defined, pre-configured, configured by a network device, determined by the terminal device, or indicated by the second terminal.

In some embodiments, the first indication information is transmitted in a third time domain resource, and the third time domain resource is determined based on the first time domain resource or the second time domain resource.

In some embodiments, a time interval between the third time domain resource and the second time domain resource is greater than or equal to a second time interval, or a time interval between the third time domain resource and the first time domain resource is greater than or equal to a third time interval.

In some embodiments, the second time interval is pre-defined, pre-configured, configured by a network device, determined by the terminal device, or indicated by the second terminal.

In some embodiments, the third time interval is pre-defined, pre-configured, configured by a network device, determined by the terminal device, or indicated by the second terminal.

In some embodiments, the first indication information is carried through a sequence.

In some embodiments, in response to that the first indication information is a first sequence, the target state is a first state; or in response to that the first indication information is a second sequence, the target state is a second state.

In some embodiments, the sequence is determined according to at least one of the following pieces of information:
a pre-configuration parameter, a parameter configured by a network device, identification information of the terminal device, identification information of the second terminal, group identification information of a communication group to which the terminal device belongs, group identification information of a communication group to which the second terminal belongs, content indicated by the first indication information, slot information corresponding to a transmission resource of the first indication information, symbol information corresponding to the transmission resource of the first indication information, a total number of subcarriers included in M physical resource blocks (PRBs), a number of subcarriers included in one PRB, or a length of the sequence, where a frequency domain resource of the sequence includes the M PRBs.

In some embodiments, the transmission resource of the first indication information includes 2 symbols.

In some embodiments, the 2 symbols include a second-to-last symbol and a third-to-last symbol in a slot that are available for sidelink transmission.

In some embodiments, same data is transmitted on the 2 symbols.

In some embodiments, the transmission resource of the first indication information is related to first information, and the first information includes at least one of the following pieces of information:
a first time domain resource, the first time domain resource being determined according to a start time of the SL-DRX duration timer or a starting position of an SL-DRX cycle;
a second time domain resource, the second time domain resource is a time domain resource of the sidelink feedback information of the first indication information;
identification information of the second terminal;
identification information of the terminal device;
content indicated by the first indication information;
a number of PRBs available for transmitting the first indication information; or
a number of cyclic shift values or cyclic shift pairs for code division multiplexing within a same frequency domain resource.

In some embodiments, a transmission resource of the first sidelink channel is related to second information, and the second information includes at least one of the following pieces of information:
identification information of the terminal device;
identification information of the second terminal;
slot information corresponding to a transmission resource of the first indication information;
symbol information corresponding to the transmission resource of the first indication information;
a first time domain resource, the first time domain resource being determined according to a start time of the SL-DRX duration timer or a starting position of an SL-DRX cycle;
starting frequency domain position information corresponding to the transmission resource of the first indication information;
frequency domain length information corresponding to the transmission resource of the first indication information;
a number of PRBs available for transmitting the first indication information; or a number of cyclic shift values or cyclic shift pairs for code division multiplexing within a same frequency domain resource.

In some embodiments, the first indication information is carried through sidelink control information (SCI) or media access control control element (MAC CE).

In some embodiments, the first indication information is carried through an information field in the SCI, or the first indication information is carried through a format of the SCI, or the first indication information is carried through a scrambling code sequence of the SCI.

In some embodiments, the first indication information is carried through first-stage SCI.

In some embodiments, the communication unit 410 is further configured to:
in response to successfully detecting the first-stage SCI, feed back acknowledgement (ACK) information to the second terminal; or
in response to unsuccessfully detecting the first-stage SCI, feed back negative acknowledgement (NACK) information to the second terminal.

In some embodiments, the first indication information is carried through second-order SCI.

In some embodiments, the communication unit 410 is further configured to:
in response to successfully detecting the second-order SCI, feed back ACK information to the second terminal; or
in response to successfully detecting first-stage SCI but unsuccessfully detecting the second-order SCI, feed back NACK information to the second terminal; or
in response to unsuccessfully detecting the first-stage SCI, feed back the NACK information to the second terminal, or not transmit the sidelink feedback information.

Optionally, in some embodiments, the communication unit may be a communication interface or a transceiver, or an input/output interface of a communication chip or a system on chip. The processing unit mentioned above may be one or more processors.

It should be understood that the terminal device 400 in accordance with the embodiments of the present disclosure may correspond to the first terminal in the method embodiments of the present disclosure, and the above-mentioned and other operations and/or functions of each unit in the terminal device 400 are respectively for implementing the corresponding processes of the first terminal device in the method 200 shown in FIGS. 12 to 18, which will not be described in detail here for the sake of brevity.

FIG. 20 is a schematic block diagram of a terminal device according to some other embodiments of the present disclosure. The terminal device 500 of FIG. 20 includes:
a communication unit 510, configured to transmit first indication information to a first terminal, the first indication information being used to indicate that the first terminal is to enter a target state; the target state being used to indicate whether the first terminal starts a first timer, or the target state being used to indicate whether the first terminal receives sidelink data within a first time range; where the first timer is related to a sidelink discontinuous reception (SL-DRX) duration timer, and the first time range is determined based on the first timer; and
receive sidelink feedback information of the first indication information transmitted by the first terminal.

In some embodiments, the target state is a first state or a second state, and the first state and the second state are different discontinuous reception (DRX) states.

In some embodiments, the first state is a wake-up state or an active state, and the second state is a sleep state or an inactive state.

In some embodiments, the target state being used to indicate whether the first terminal starts the first timer, or the target state being used to indicate whether the first terminal receives the sidelink data within the first time range, includes that:
in response to that the target state is a wake-up state or an active state, the first terminal starts the first timer, or the first terminal receives the sidelink data within the first time range; or
in response to that the target state is a sleep state or an inactive state, the first terminal does not start the first timer, or the first terminal does not receive the sidelink data within the first time range.

In some embodiments, the sidelink feedback information is carried through a first sidelink channel.

In some embodiments, the first sidelink channel is transmitted in a second time domain resource, the second time domain resource is related to a first time domain resource, and the first time domain resource is determined according to a start time of the SL-DRX duration timer or a starting position of an SL-DRX cycle.

In some embodiments, the second time domain resource is before the first time domain resource, or the second time domain resource is after the first time domain resource.

In some embodiments, a time interval between the second time domain resource and the first time domain resource is greater than or equal to a first time interval.

In some embodiments, the first time interval is pre-defined, pre-configured, configured by a network device, determined by the first terminal, or indicated by the terminal device.

In some embodiments, the first indication information is transmitted in a third time domain resource, and the third time domain resource is determined based on the first time domain resource or the second time domain resource.

In some embodiments, a time interval between the third time domain resource and the second time domain resource is greater than or equal to a second time interval, or a time interval between the third time domain resource and the first time domain resource is greater than or equal to a third time interval.

In some embodiments, the second time interval is pre-defined, pre-configured, configured by a network device, determined by the first terminal, or indicated by the terminal device.

In some embodiments, the third time interval is pre-defined, pre-configured, configured by a network device, determined by the first terminal, or indicated by the terminal device.

In some embodiments, the first indication information is carried through a sequence.

In some embodiments, in response to that the first indication information is a first sequence, the target state is a first state; or in response to that the first indication information is a second sequence, the target state is a second state.

In some embodiments, the sequence is determined according to at least one of the following pieces of information:
a pre-configuration parameter, a parameter configured by a network device, identification information of the first terminal, identification information of the terminal device, group identification information of a communication group to which the first terminal belongs, group identification information of a communication group to which the terminal device belongs, content indicated by the first indication information, slot information corresponding to a transmission resource of the first indication information, symbol information corresponding to the transmission resource of the first indication information, a total number of subcarriers included in M physical resource blocks (PRBs), a number of subcarriers included in one PRB, or a length of the sequence, where a frequency domain resource of the sequence includes the M PRBs.

In some embodiments, the transmission resource of the first indication information includes 2 symbols.

In some embodiments, the 2 symbols include a second-to-last symbol and a third-to-last symbol in a slot that are available for sidelink transmission.

In some embodiments, same data is transmitted on the 2 symbols.

In some embodiments, the transmission resource of the first indication information is related to first information, and the first information includes at least one of the following pieces of information:
a first time domain resource, the first time domain resource being determined according to a start time of the SL-DRX duration timer or a starting position of an SL-DRX cycle;
a second time domain resource, the second time domain resource is a time domain resource of the sidelink feedback information of the first indication information;
identification information of the terminal device;
identification information of the first terminal;
content indicated by the first indication information;
a number of PRBs available for transmitting the first indication information; or
a number of cyclic shift values or cyclic shift pairs for code division multiplexing within a same frequency domain resource.

In some embodiments, a transmission resource of the first sidelink channel is related to second information, and the second information includes at least one of the following pieces of information:
identification information of the first terminal;
identification information of the terminal device;
slot information corresponding to a transmission resource of the first indication information;
symbol information corresponding to the transmission resource of the first indication information;
a first time domain resource, the first time domain resource being determined according to a start time of the SL-DRX duration timer or a starting position of an SL-DRX cycle;
starting frequency domain position information corresponding to the transmission resource of the first indication information;
frequency domain length information corresponding to the transmission resource of the first indication information;
a number of PRBs available for transmitting the first indication information; or
a number of cyclic shift values or cyclic shift pairs for code division multiplexing within a same frequency domain resource.

In some embodiments, the first indication information is carried through sidelink control information (SCI) or media access control control element (MAC CE).

In some embodiments, the first indication information is carried through an information field in the SCI, or the first indication information is carried through a format of the SCI, or the first indication information is carried through a scrambling code sequence of the SCI.

In some embodiments, the first indication information is carried through first-stage SCI.

In some embodiments, the first indication information is carried through second-order SCI.

Optionally, in some embodiments, the communication unit may be a communication interface or a transceiver, or an input/output interface of a communication chip or a system on chip. The processing unit mentioned above may be one or more processors.

It should be understood that the terminal device 500 in accordance with the embodiments of the present disclosure may correspond to the second terminal in the method embodiments of the present disclosure, and the above-mentioned and other operations and/or functions of each unit in the terminal device 500 are respectively for implementing the corresponding processes of the second terminal device in the method 200 shown in FIGS. 12 to 18, which will not be described in detail here for the sake of brevity.

FIG. 21 is a schematic structural diagram of a communication device 600 provided in embodiments of the present disclosure. The communication device 600 shown in FIG. 21 includes a processor 610. The processor 610 may call a computer program from a memory and run the computer program to implement the method in the embodiments of the present disclosure.

Optionally, as shown in FIG. 21, the communication device 600 may further include a memory 620. The processor 610 may call a computer program from the memory 620 and run the computer program to implement the method in the embodiments of the present disclosure.

Here, the memory 620 may be a separate device independent of the processor 610, or may be integrated into the processor 610.

Optionally, as shown in FIG. 21, the communication device 600 may further include a transceiver 630. The processor 610 may control the transceiver 630 to communicate with other devices, and for example, may control the transceiver 630 to transmit information or data to other devices, or control the transceiver 630 to receive information or data transmitted by other devices.

Here, the transceiver 630 may include a transmitter and a receiver. The transceiver 630 may further include an antenna, and the number of the antenna may be one or more.

Optionally, the communication device 600 may be the first terminal of the embodiments of the present disclosure, and the communication device 600 may implement the corresponding processes implemented by the first terminal in each method of the embodiments of the present disclosure, which will not be described in detail here for the sake of brevity.

Optionally, the communication device 600 may be the second terminal of the embodiments of the present disclosure, and the communication device 600 may implement the corresponding processes implemented by the second terminal in each method of the embodiments of the present disclosure, which will not be described in detail here for the sake of brevity.

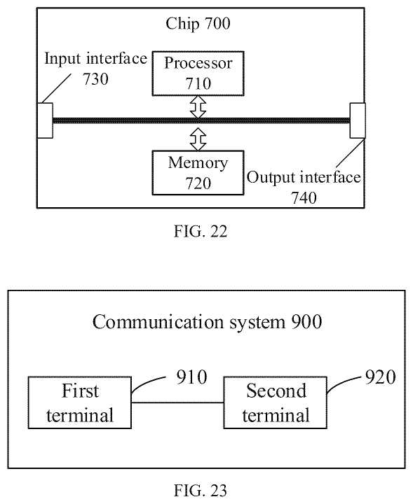

FIG. 22 is a schematic structural diagram of a chip of the embodiments of the present disclosure. The chip 700 shown in FIG. 22 includes a processor 710. The processor 710 may call a computer program from a memory and run the computer program to implement the method in the embodiments of the present disclosure.

Optionally, as shown in FIG. 22, the chip 700 may further include a memory 720. The processor 710 may call a computer program from the memory 720 and run the computer program to implement the method in the embodiments of the present disclosure.

Here, the memory 720 may be a separate device independent of the processor 710, or may be integrated into the processor 710.

Optionally, the chip 700 may further include an input interface 730. The processor 710 may control the input interface 730 to communicate with other devices or chips, and for example, may control the input interface 730 to obtain information or data transmitted by other devices or chips.

Optionally, the chip 700 may further include an output interface 740. The processor 710 may control the output interface 740 to communicate with other devices or chips, and for example, may control the input interface 730 to output information or data to other devices or chips.

Optionally, the chip may be applied to the first terminal in the embodiments of the present disclosure, and the chip may implement the corresponding processes implemented by the first terminal in each method of the embodiments of the present disclosure, which will not be described in detail here for the sake of brevity.

Optionally, the chip may be applied to the second terminal in the embodiments of the present disclosure, and the chip may implement the corresponding processes implemented by the second terminal in each method of the embodiments of the present disclosure, which will not be described in detail here for the sake of brevity.

It should be understood that the chip mentioned in the embodiments of the present disclosure may also be called a system-level chip, a system chip, a chip system, or a system-on-chip chip, etc.

FIG. 23 is a schematic block diagram of a communication system 900 provided in embodiments of the present disclosure. As shown in FIG. 23, the communication system 900 includes a first terminal 910 and a second terminal 920.

Here, the first terminal 910 may be used to implement the corresponding functions implemented by the first terminal in the above method, and the second terminal 920 may be used to implement the corresponding functions implemented by the second terminal in the above method, which will not be described in detail here for the sake of brevity.

It should be understood that the processor of the embodiments of the present disclosure may be an integrated circuit chip with signal processing capabilities. In the implementation process, each step of the above method embodiments may be completed by an integrated logic circuit of hardware in a processor or an instruction in software form. The above-mentioned processor may be a general-purpose processor, a digital signal processor (DSP), an application-specific integrated circuit (ASIC), a field programmable gate array (FPGA) or any of other programmable logic devices, discrete gate or transistor logic device, or a discrete hardware component, which may implement or perform various methods, steps and logic block diagrams disclosed in the embodiments of the present disclosure. A general-purpose processor may be a microprocessor, or the processor may be any conventional processor or the like. The steps of the method disclosed in the embodiments of the present disclosure may be directly implemented as being performed by a hardware decoding processor, or may be implemented by a combination of hardware and software modules in the decoding processor. The software module may be located in a random access memory, a flash memory, a read-only memory, a programmable read-only memory, an electrically erasable programmable memory, a register, or other mature storage media in the art. The storage medium is located in the memory, and the processor reads the information in the memory and completes the steps of the above method in combination with its hardware.

It may be understood that the memory in the embodiments of the present disclosure may be a volatile/transitory memory or a non-volatile/non-transitory memory, or may include both volatile/transitory and non-volatile/non-transitory memories. Here, the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile/transitory memory may be a random access memory (RAM), which acts as external cache memory. By way of example and not limitation, many forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DR RAM). It should be noted that memory of the systems and methods described herein is intended to include, without being limited to, these and any other suitable types of memory.

It should be understood that the above-mentioned memories are exemplary but not restrictive. For example, the memory in the embodiments of the present disclosure may also be a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), a direct memory bus random access memory (Direct Rambus RAM, DR RAM), or the like. That is, the memories in the embodiments of the present disclosure are intended to include, but are not limited to, these and any other suitable types of memories.

The embodiments of the present disclosure further provide a non-transitory computer-readable storage medium for storing a computer program.

Optionally, the non-transitory computer-readable storage medium may be applied to the first terminal in the embodiments of the present disclosure, and the computer program enables a computer to perform the corresponding processes implemented by the first terminal in each method of the embodiments of the present disclosure, which will not be described in detail here for the sake of brevity.

Optionally, the non-transitory computer-readable storage medium may be applied to the second terminal in the embodiments of the present disclosure, and the computer program enables a computer to perform the corresponding processes implemented by the second terminal in each method of the embodiments of the present disclosure, which will not be described in detail here for the sake of brevity.

The embodiments of the present disclosure further provide a computer program product including computer program instructions.

Optionally, the computer program product may be applied to the first terminal in the embodiments of the present disclosure, and the computer program instructions enable a computer to perform the corresponding processes implemented by the first terminal in each method of the embodiments of the present disclosure, which will not be described in detail here for the sake of brevity.

Optionally, the computer program product may be applied to the second terminal in the embodiments of the present disclosure, and the computer program instructions enable a computer to perform the corresponding processes implemented by the second terminal in each method of the embodiments of the present disclosure, which will not be described in detail here for the sake of brevity.

The embodiments of the present disclosure further provide a computer program.

Optionally, the computer program may be applied to the first terminal in the embodiments of the present disclosure. When the computer program runs on a computer, the computer is enabled to perform the corresponding processes implemented by the first terminal in each method of the embodiments of the present disclosure, which will not be described in detail here for the sake of brevity.

Optionally, the computer program may be applied to the second terminal in the embodiments of the present disclosure. When the computer program runs on a computer, the computer is enabled to perform the corresponding processes implemented by the second terminal in each method of the embodiments of the present disclosure, which will not be described in detail here for the sake of brevity.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the application and design constraints of the technical solution. Professional technicians may use different methods to implement the described functions for each application, but such implementation should not be considered to be beyond the scope of the present disclosure.

Those skilled in the art can clearly understand that for the convenience and brevity of description, the working processes of the systems, devices and units described above may refer to the corresponding processes in the aforementioned method embodiments and will not be described in detail here.

In several embodiments provided in the present disclosure, it should be understood that the disclosed systems, devices, and methods may be implemented in other ways. For example, the device embodiments described above are merely illustrative. For example, the division of the units is merely a logical function division. There may be other division methods in actual implementations. For example, multiple units or components may be combined or integrated into another system, or some features may be ignored or not performed. Another point is that the mutual coupling or direct coupling or communication connection shown or discussed may be an indirect coupling or communication connection through some interfaces, devices or units, which may be electrical, mechanical or other forms.

The units described as separate components may or may not be physically separated, and the components shown as units may or may not be physical units, that is, they may be located in one place or distributed over multiple network units. Some or all of the units may be selected according to actual needs to accomplish the purpose of the solution of the embodiments.

In addition, various functional units in various embodiments of the present disclosure may be integrated into one processing unit, or each unit may exist physically separately, or two or more units may be integrated into one unit.

If being implemented in the form of a software functional unit and sold or used as an independent product, the described functions may be stored in a non-transitory computer-readable storage medium. For this understanding, the technical solution of the present application essentially, or a part of the technical solution that contributes to the related art, or a part of the technical solution, may be embodied in the form of a software product, and the computer software product is stored in a storage medium, and includes several instructions for enabling a computer device (which may be a personal computer, a server, a network device, or the like) to perform all or some of steps of the methods described in various embodiments of the present disclosure. And, the storage media mentioned above include various media capable of storing program codes, such as a USB flash drive (U disk), a mobile hard disk, a read-only memory (ROM), a random access memory (RAM), a diskette, and an optical disk.

The above description is only exemplary implementations of the present disclosure, but the protection scope of the present disclosure is not limited thereto, and any technician familiar with the technical field may easily think of changes or substitutions within the technical scope disclosed in the present disclosure, which should all be covered within the protection scope of the present disclosure. Therefore, the protection scope of the present disclosure shall be subject to the protection scope of the claims.

What is claimed is:

1. A wireless communication method, comprising:
detecting, by a first terminal, first indication information transmitted by a second terminal, the first indication information being used to indicate that the first terminal is to enter a target state; the target state being used to indicate whether the first terminal starts a first timer, or the target state being used to indicate whether the first terminal receives sidelink data within a first time range; wherein the first timer is related to a sidelink discontinuous reception (SL-DRX) duration timer, and the first time range is determined based on the first timer; and
transmitting, by the first terminal, sidelink feedback information of the first indication information to the second terminal.

2. The method according to claim 1, wherein the target state is a first state or a second state, and the first state and the second state are different discontinuous reception (DRX) states.

3. The method according to claim 2, wherein the first state is a wake-up state or an active state, and the second state is a sleep state or an inactive state.

4. The method according to claim 1, wherein the target state being used to indicate whether the first terminal starts the first timer, or the target state being used to indicate whether the first terminal receives the sidelink data within the first time range, comprises that:
in response to that the target state is a wake-up state or an active state, the first terminal starts the first timer.

5. The method according to claim 1, wherein the sidelink feedback information is carried through a first sidelink channel.

6. The method according to claim 5, wherein the first sidelink channel is transmitted in a second time domain resource, the second time domain resource is related to a first time domain resource, and the first time domain resource is determined according to a start time of the SL-DRX duration timer.

7. The method according to claim 6, wherein the second time domain resource is after the first time domain resource.

8. The method according to claim 6, wherein a time interval between the second time domain resource and the first time domain resource is greater than or equal to a first time interval;
the first time interval is pre-configured, or configured by a network device.

9. The method according to claim 1, wherein the sidelink feedback information of the first indication information is carried through a first sidelink channel, a transmission resource of the first sidelink channel is related to second information, and the second information comprises at least one of following pieces of information:
identification information of the first terminal;
identification information of the second terminal;
slot information corresponding to a transmission resource of the first indication information;
starting frequency domain position information corresponding to the transmission resource of the first indication information; or
a number of cyclic shift values or cyclic shift pairs for code division multiplexing within a same frequency domain resource.

10. The method according to claim 1, wherein the first indication information is carried through sidelink control information (SCI);
wherein the first indication information is carried through first-stage SCI.

11. A terminal device, comprising: a processor and a memory, the memory being configured to store a computer program, and the processor being configured to call the computer program stored in the memory and run the computer program, to cause the terminal device to perform:
detecting first indication information transmitted by a second terminal, the first indication information being used to indicate that the first terminal is to enter a target state; the target state being used to indicate whether the first terminal starts a first timer, or the target state being used to indicate whether the first terminal receives sidelink data within a first time range; wherein the first timer is related to a sidelink discontinuous reception (SL-DRX) duration timer, and the first time range is determined based on the first timer; and
transmitting sidelink feedback information of the first indication information to the second terminal.

12. The terminal device according to claim 11, wherein the target state is a first state or a second state, and the first state and the second state are different discontinuous reception (DRX) states.

13. The terminal device according to claim 12, wherein the first state is a wake-up state or an active state, and the second state is a sleep state or an inactive state.

14. The terminal device according to claim 11, wherein the target state being used to indicate whether the first terminal starts the first timer, or the target state being used to indicate whether the first terminal receives the sidelink data within the first time range, comprises that:
in response to that the target state is a wake-up state or an active state, the first terminal starts the first timer.

15. The terminal device according to claim 11, wherein the sidelink feedback information is carried through a first sidelink channel.

16. The terminal device according to claim 15, wherein the first sidelink channel is transmitted in a second time domain resource, the second time domain resource is related to a first time domain resource, and the first time domain resource is determined according to a start time of the SL-DRX duration timer.

17. The terminal device according to claim 16, wherein the second time domain resource is after the first time domain resource.

18. The terminal device according to claim 16, wherein a time interval between the second time domain resource and the first time domain resource is greater than or equal to a first time interval;
the first time interval is pre-configured, configured by a network device.

19. The terminal device according to claim 11, wherein the sidelink feedback information of the first indication information is carried through a first sidelink channel, a transmission resource of the first sidelink channel is related to second information, and the second information comprises at least one of following pieces of information:
identification information of the first terminal;
identification information of the second terminal;
slot information corresponding to a transmission resource of the first indication information;
starting frequency domain position information corresponding to the transmission resource of the first indication information; or
a number of cyclic shift values or cyclic shift pairs for code division multiplexing within a same frequency domain resource.

20. The terminal device according to claim 11, wherein the first indication information is carried through sidelink control information (SCI);
wherein the first indication information is carried through first-stage SCI.
